(19) United States
(12) Patent Application Publication
(10) Pub. No.: US 2009/0068625 A1
(43) Pub. Date: Mar. 12, 2009

(54) ALPHIE: an algorithmic system and method for teaching and learning writing and reading

(76) Inventors: John Creighton Petro, Lincoln, NE (US); John George Petro, Miami, FL (US)

Correspondence Address: J. CREIGHTON PETRO, 2800 FLETCHER AVE # 19, LINCOLN, NE, 68504, US

(21) Appl. No.: 11/853,981

(22) Filed: Sep. 12, 2007

(51) Int. Cl. G09B 11/00; G09B 1/00

(52) U.S. Cl. 434/160; 434/162; 434/167; 434/238

(57) ABSTRACT

This invention is an integrated alphabetic language teaching system that facilitates teaching multiple levels of the arts of writing and reading to individuals aged one year and older.

This invention reverses traditional methods of written language development by enabling writing prior and preliminary to reading.

This invention initially teaches a set of orthographic graphemic segmental strokes by drawing geometric constructs called instructional entities composed entirely of the same orthographic graphemic segmental strokes that will subsequently be individually taught and practiced, thereby providing a student with a fundamental enabling skill with which the entire sets of 26 majuscule, 26 miniscule, 10 numerals, 14 punctuation marks and the entire lexicon of the English and other alphabetic languages may be constructed.

This invention uses printed grids of elicitation frames into which, initially, elicited graphemic segmental strokes are drawn, then progresses to the elicitation of complete graphemes, then progresses to the elicitation of complete words, and subsequently progresses through the elicitation of complete phrases and sentences.

### CROSS-REFERENCE TO RELATED APPLICATIONS

Not Applicable

### STATEMENT REGARDING FEDERALLY SPONSORED RESEARCH

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Technical Field

This invention relates generally to a method and system for teaching multiple aspects of language skills by a series program. Particularly, the invention relates to a method and system for teaching the arts of writing and reading commencable with persons aged one year and older initially through instruction in forming, recognizing and non-sequentially arranging letters of the alphabet and progressing to arrangement of groups of letters into words and sentences pursuant to a finite list of well defined instructions.

2. Description of Prior Art and State of Technology

The present invention can most simply be described as an algorithmic system and method for enabling children to learn to write before learning to read. The system incorporates within itself a metacognital learning progression and an additional learning algorithm which potentiate the writing and reading learning system and methods of the invention.

The system commences, for the youngest child-students, with learning and development of a sensorimotor motor skill involving early primitive scribblings and artwork enthusiastically created by all children. The skill of scribbling is gradually refined by the system into the skill of making selected strokes which are then further refined and expanded into the semi-automatic skill of drawing graphemes. The system progresses through the enablement of students to write before learning to read, and also, as a direct consequence of learning to write, to simultaneously thereby learn to read and comprehend what they have written. The system ultimately progresses through multiple levels enabling students to develop advanced reading and writing skills. The specific content matter presented during each step of the progression has been chosen to foster and maintain a sequence of natural relevance based on expressions of self interest and degrees of interest of the student. The system utilizes a frame and content structure supplemented by oral instruction, inspiration and instigation by a teacher. The system places great emphasis on the development of the sub-skill of learning how to learn in order to develop the primary skills of writing and reading.

In contrast, at the present time, in both public and private schools, pre-school and school system children are commonly taught to read before learning to write. Very little sensorimotor learning is incorporated into the process, and little to no emphasis is placed on teaching a child how to learn. There is little or no natural relevance of the subject matter connecting the student to it, and the natural degree of interest in the subject matter is generally low. Although writing is taught as an integrated component with learning to read in one known system, handwriting is emphasized, memorization of an extensive vocabulary of more than a hundred and fifty words is required before the actual written element is introduced, pre-writing activities consist of stringing beads, cutting, pasting and coloring, teaching of higher level learning skills is not considered possible until later in the program, and the program is not intended for use prior to kindergarten or first grade. Therefore, teaching to write before teaching to read and incorporating this instruction with natural relevance and development of the metacognitive skill of learning how to learn constitute a paradigm reversal, and the need for such a reversal and the value thereof will be demonstrated in this background synopsis as it reviews more than thirty deficiencies in the current state of the art and prior art.

An appreciable body of research based knowledge has accumulated wherein it is indicated that:
a. In learning a skill, conscious attention to its critical features facilitates acquisition of the skill;
b. The more personally meaningful the material to be learned, the greater the facility in learning and retention;
c. Learning based on growth or expansion of previously acquired skill or knowledge is faster and better learned than original material or skill;
d. Individuated instruction fitted to the individual needs, preferences and capacities of the learner produces superior results;
e. The more numerous kinds of association that are made to an item, the better are learning and retention of information concerning the item;

In addition, universities and institutions globally are producing an ever increasing number of validated studies indicating that:
a. Passive learning is immeasurably inferior to active learning;
b. Materials presented visually are more easily learned than comparable materials presented aurally;
c. the frequency with which an item is practiced per se is not as crucial as the frequency with which it is contrasted with other items with which it may be confused;
d. Superior results are achieved when realistic evaluation criteria dictate maintaining or altering activities in accord with the results they achieve.
e. Positive affective states increase performance on various tasks such as memory and discrimination;
f. Inducing positive feelings in children facilitates the learning of new information;
g. Positive affective states result in more efficient utilization of cognitive material than neutral or negative moods;
h. Building of positive affective states utilizing self instruction reduces the anticipation of failure and corresponding decrease in ability to concentrate and difficulty applying previously acquired skills.
i. Positive affective states influence cognitive organization such that cognitive material is more integrated and related;
j. All teachers have the potential to be instrumental in addressing the complex interaction of emotional concerns and learning processes in children.

Despite this impressive body of knowledge from which one might surmise that teaching reading and writing to children should be an easy task, a Fordham Foundation report published in October, 2000, claims that four in ten of United States fourth graders lack basic reading skills. (The American Federation of Teachers claims that the rate of reading failure for African-American, Hispanic, limited-English and poor children ranges from 60% to 70%). The same Fordham report stresses that the most important skill in the beginning stages of reading is the ability to read single words completely, accurately and fluently. The present invention is specifically designed to enable and enhance in children the ability to read single words completely, accurately and fluently, and to so enable them in a different manner and at an earlier age than any other currently available system.

If an average of four out of ten American fourth graders are deficient in basic reading skills, it is probable that there are numerous problems in the current teaching systems which are at least partially at fault. Moreover, the problems are not limited to a single grade level or age group. In fact, many studies such as the one conducted by the National Institute for Literacy (also published in 2000) utilizing data collected by the U.S. Department of Education report deplorably high levels of illiteracy across all age levels. The NIL report claims that in many southern states, the illiteracy rate exceeds 40% to 50% of the adult population. An even greater catastrophe can be seen in the reports of many northern, southern and western cities where over 60 percent of the adult population, more than one out of two people, could not perform above the Level I literacy rate, that is, they could not fill out an application form for a Social Security card, write a letter, or read the instructions on a bottle of medicine. California recorded six cities in this category. Miami, Fla. reported 63 percent of its residents at the Level I literacy level. In the state of Michigan, 18 percent of adults, nearly one in five, were functionally illiterate. Detroit had the one of the highest illiteracy rates in the country, with 47 percent of its residents, nearly one out of two, scoring at Level I in the NIL survey. Other English teaching countries report similar problems. An Australian government study in 2005 reported that more than 20% of their students are functionally illiterate upon graduation.

The present invention addresses and corrects or improves upon more than thirty problem areas in the current teaching systems and prior art:
1. Problem: Reading programs generally do not commence until the child attains school age or older. A number of useful reading developmental years are lost.
Improvement: Reading and writing commence simultaneously and may commence as soon as a child is sufficiently prehensile to hold a marking implement. A child of age 4 can write, read and comprehend compound sentences of twenty words and more.
2. Problem: Writing programs generally do not commence until after reading programs have commenced and progressed for a year or more when children are five, six or seven years of age. Additional developmental time is lost.
Improvement: The writing program actually commences when the child can make marks on a surface such as paper. Developmental time is gained, up to 5 years.
3. Problem: Timely and realistic evaluation criteria are needed, but are generally not available, to dictate whether to maintain or alter activities in accordance with results achieved.
Improvement: The design of the system provides timely and realistic evaluation criteria and aids in altering activities in accordance with results achieved. In addition to aiding skill development in normal children, these evaluation criteria also provide valuable indicators for early professional intervention for children whose progress indicates such need.
4. Problem. Self evaluation and self analysis are generally not provided for and therefore are not possible, and there is generally no attempt by teachers in early grades to independently teach children self evaluation.
Improvement: Self evaluation and self analysis are part of the design of the system and written elements are easily visually compared by the student to authentic examples to validate their own work. Self validation builds and strengthens positive affective mental states within the student, enhancing focus, concentration and learning in the student. In addition, the present invention teaches students to monitor their own progress towards their goals. These tools and conditions are all essential elements for developing learning to learn skills in the student.
5. Problem: Instant feedback is only occasionally available from the teacher.
Improvement: During the early foundational levels of the program, instant feedback is always available because the student always sees what he is attempting to write juxtaposed with correct examples.
6. Problem: Frequent frustration leads to loss of self esteem and loss of interest with a corresponding diminution of focus and concentration.
Improvement: Instant feedback reduces frustration and leads to self generating corrective efforts which increase personal satisfaction and self esteem. Enhanced self esteem is a positive affective state that correlatively results in more efficient utilization of cognitive material than neutral or negative moods, facilitates the learning of new information, reduces the anticipation of failure and corresponding negative consequences such as anger and acting out, and influences cognitive organization such that cognitive material is more integrated and related. These tools and conditions are also essential elements for developing learning to learn skills in the student.
7. Problem: Visual feedback is not possible in typical reading programs.
Improvement: Visual feedback is built into the system and is readily available to the student. In addition, seeking out of feedback by the student is an important step in learning how to learn.
8. Problem: Frequency of contrasting elements is limited to aural presentations in a reading first scenario.
Improvement: Elements are contrasted frequently because they are written and visually accessible as well as noticeable aurally. In addition, learning is potentiated by constant alternation among varied patterns.
9. Problem: Material is limited to generalized text, is not personalized, and contains little or no natural relevance to the student.
Improvement: Material is considerably more relevant and meaningful because the system immediately incorporates current and prior artistic and linguistic efforts and productions of the child into the materials being studied thereby stimulating conscious attention to, and focus upon, the subject matter. Early emphasis on use of the word “I” further incorporates the child into the subject matter, additionally potentiating focus and attention while developing a natural relevance and elevated degree of interest.
10. Problem: There is little or no motor performance in reading first teaching methods.
Improvement: Motor performance is included from age 1 and up because this is a writing-first teaching method. Inclusion of motor performance is known to enhance the learning experience by creating an ownership experience not possible with typical audial and visual experiences.
11. Problem: Active participation is limited.
Improvement: Active participation is enhanced through writing motor performance as well as inclusion of the student in the subject matter and involvement of the student in the construction of the materials, and focuses conscious attention on the subject matter.
12. Problem: Individuation is nearly impossible in most generalized teaching methods.
Improvement: Complete individuation is possible and provided. The system anticipates, allows and provides for students of mixed ages and skill level attainment without interference with or interruption of the typical classroom setting.
13. Problem: There is little control of a large number of simultaneously varying and interacting factors such as a child's capabilities and prior experience.
Improvement: There is far greater control of varying factors by virtue of individuation. The observant instructor is enabled to pursue alternative possibilities for individual students by virtue of greater number of opportunities that individuation presents.
14. Problem: There is involvement of only two senses in general reading instruction: sight and sound.
Improvement: Three senses are involved: sight, sound and touch.
15. Problem: Only one learning technique is generally involved in early language instruction: imitation of sounds.
Improvement: Four learning techniques are generally integrated: imitation of sounds, analogy pattern drills, analysis of observed results and multiple associations of segmental elements.
16. Problem: There is generally an absence of the complete learning experience in traditional reading-first teaching methods.
Improvement: The complete experience of writing, reading and listening is provided, thereby teaching in the three modalities of kinesthetic, visual and audial learning.
17. Problem: There is little emotional salience in the reading-first teaching method.
Improvement: There is considerable emotional salience built into the system by participation of the student in the construction of the subject matter and inclusion of the student's own persona and personal data, the student's artistic and linguistic work production, the student's interpretations of his own productions, the student's modifications and alterations of his own productions, and the student's new work productions in the subject matter itself.
18. Problem: Biologic time frames of the student are only partially observed.
Improvement: Biologic time frames are better observed by virtue of being able to begin the teaching process considerably earlier in the child's life. Babies and toddlers are fully capable of conducting metacognital activities that will initiate and potentiate their learning skills.
19. Problem: Clearly defined and stated goals are generally not provided in the traditional reading first teaching method. Equally important, there is generally no attempt by teachers in early grades to teach children about the importance of goal setting.
Improvement: Clearly defined goals are part of the system design and are achievable at the individuated pace of the student. Successful students set goals for themselves. The present invention teaches students to set goals.
20 Problem: Traditional teaching methods are age driven regardless of experience, capability, prior knowledge or prior accomplishment of the student.
Improvement: The present invention is levels driven and therefore it is essentially competition free and failure free. By virtue of individuation, the student is allowed to compete only with his own desire to progress to the next level.
21. Problem: Teachers are generally untrained in, and inadequately supplied with materials suitable for, addressing the complex interaction of emotional factors affecting children in a learning environment.
Improvement: Charting the accomplishments of each student is part of the system of the present invention. The chart allows the observant teacher to take early notice of under performing children and to take actions ranging from simply praising a child's efforts to affect an increase in confidence and self esteem in the child, to recommending professional guidance or intervention on behalf of the child.
22. Problem: Teachers experience frustration and anger with under performing children resulting in reduced patience with and reduced attention to the child in general.
Improvement: The present invention is levels driven and individuated, thereby not only allowing but, in effect, requiring constant monitoring of the student's accomplishments and class position and correspondingly requiring greater attention from the teacher to bring a student into line with class levels in general and into line with the student's capabilities in particular.
23. Problem: Teachers do not have the time to pursue classroom data collection and analysis.
Improvement: Data is collected on a daily basis and requires no more time than traditional methods of marking attendance records. Analysis is by simple observation of the self generating chart that evolves from the data collection process.
24. Problem: There is generally no concomitant material intended for parental participation in the student's literacy education.
Improvement: Parental participation is designed into the system as are appropriate concomitant materials.
25. Problem: There is generally no attempt by teachers in early grades to teach children to learn how to learn.
Improvement: The present invention is metacognitively oriented so that the student is trained to develop and employ metacognitive strategies to focus their attention, enhance salience, derive meaning, and establish and maintain motivation.
26. Problem: There is generally no attempt by teachers in early grades to teach children attention control.
Improvement: Attention control is a metacognitive skill and is taught by the system of the present invention along with other metacognitive skills such as “self talk” which helps to direct and focus attention, obtain feedback and make adjustments to their efforts.
27. Problem: There is generally no attempt by teachers in early grades to develop basic metacognitive skills in children.
Improvement: Very young children possess the beginnings of cognitive and metacognitive skills By mimicry, for example, toddlers take on attitudes and roles from others and incorporate them into their own persons and personalities. The present invention assists students to develop metacognitive skills by training them to direct their attention, transfer strategies to new situations, and make attributions to themselves of skills they possess, that is, to make the acknowledgement that “I can do this”, among others.
28. Problem: There is generally no attempt by teachers in early grades to teach children cognitive restructuring.
Improvement: The present invention teaches students cognitive restructuring which means that the learner is taught to use intellectual processes to think about or state in a different manner the information or task he is trying to process or accomplish. Restatement makes it more likely that the subject matter under study will be the focus of attention in the working memory of the student.
29. Problem: There is generally no attempt by teachers in early grades to teach children self regulation of learning.
Improvement: Students of any age are capable of taking some degree of charge of their own learning. For example, babies exhibit self regulation when they choose to play, or not to play, with crib toys and mobiles. The present invention teaches students to self regulate by teaching task analysis, goal setting, progress monitoring and strategy adjustment.
30. Problem: Intrinsic enthusiasm and desire for understanding appears lost or undermined in older school aged children despite the fact that self directed learning is a natural behavior for young children.
Improvement: The present invention supports informational reinforcement through goal setting, goal monitoring, success monitoring and other techniques that enhance intrinsic motivation and enthusiasm.
31. Problem: An “Assessment Institute for Elementary Principals” was conducted in 2001 by the Southern California Comprehensive Assistance Center, Los Angeles County Office of Education, in response to interviews in which elementary school principals discussed classroom assessment data and how they are used in schools. According to the principals, they were expected to use data in their decision making, but had never been provided with the necessary knowledge and skills. Similarly, they were expected to promote the use of data among their teachers, but were not taught how to do so. When questioned as to their professional development needs, the principals:
   1. Recognized classroom assessment data were critical to instructional decision making.
   2. Emphasized the limitations of professional development sessions, in which there wasn't enough time to practice new skills.
   3. Stated they needed strategies for helping teachers use classroom data for instructional decision making.
   4. Asked for ideas and examples to help them integrate data into their daily work.
Improvement: As collected and visually presented in the registration form, the classroom data constitute a simple quantitative model of change, the general term for which is calculus. The fundamental idea of calculus is to study change, by which is meant changes over small intervals of time. By studying how things change or can be changed over time, calculus provides a framework for modeling systems in which there is change. The data in the registration and learning progress form provide observant instructors with the ability to fend the effects of changing conditions and consequently to control the system to make it do what the instructor wants it to do. The data in the registration and learning progress form may therefore be described as a probability calculus wherein the causal interpretation contains three classes of probabilities:
   1. achievement probabilities representing the probability that a lesson goal can be achieved;
   2. performance probabilities representing the probability that the desired result of a lesson will be achieved if the prescribed performance is executed, and
   3. level modification probabilities representing the probability that a student's level of accomplishment can be modified, that is, improved by decrease or increase, given that the current level is deemed inappropriate, insufficient or inadequate by the instructor or other assessing person or body.
32. Problem: At the 2001 “Assessment Institute for Elementary Principals”, principals reported they needed user-friendly tools and strategies for working with data, as they and their teachers could not be expected to become experts in statistics.
Improvement: It is understandable that an instructor not specifically trained in mathematic arts might have a fear of or an aversion to mathematic techniques of analysis of data. Without regard or concern for or reference to such potentially troublesome terms as statistical analysis and calculus, an observant instructor can nevertheless easily make use of the collected data presented on the registration form to both analyze and to make the daily decisions regarding which particular lessons to offer to which individual students, and other decisions such as how to group students in the most effective manner. For example, one or more students may simply require additional practice to meet an expectation before moving on to the next prescribed lesson. Another student or students who don't understand the basic concept and/or skills targeted by the teacher may require a “re-teach” level of support. Still other students may have very different needs from one another and may require special interventions. Using data that is self generating and self charting on the registration form offers a powerful individuated instruction capability to all observant instructors making appropriate use of the system.
33. Problem: In most cases, classroom data merely take the form of an alphabetical list of students and dates of attendance or absence which does not easily lend itself to data analysis.
Improvement: Data contained on the registration form are organized and displayed so that patterns or rates of accomplishment for individual students are clearly evident. In effect, the data in the form are organized in the form of a range and distribution or, more simply stated, the data in the form are self organizing in the form of a chart or a graph that requires no expertise in statistical analysis to understand and utilize. Of significant importance is the fact that the collection, organization and visual display of the data literally requires only minutes of the instructor's daily time. In addition, the data in the form are integrated into the work flow of the instructors and constitute a self generating strategy for daily instructional decision making.
34. Problem: A classroom emphasis on phonological processes assumes that teachers already have the necessary understanding of phonemic awareness required to teach it effectively. This assumption may not be warranted, as research has indicated that many teachers do not themselves have a solid foundation in their own phonemic awareness, and few have received the level of training that produces the skill level important in awakening children's fine grained sensitivity to the sound structure of words. For example, in one American study, only 2% of teachers-in-training and only 19% of working teachers could correctly identify the speech sounds from which the word “box” is constructed. The problem is not unique to America. In 2005, the Australian government issued a report in response to learning that upon leaving school, more than 20% of the country's children are functionally illiterate. The Australian report recommended:
   1. an overhaul of teacher training systems;
   2. that teacher education should include more specific and evidence based training;
   3. intensive training for teachers already working;
   4. reform in pre-school education philosophies and training of pre-school teachers; and
   5. preparation of children for reading through pre-reading activities including an introduction to letters.
Improvement: The system beneficially addresses the concerns and recommendations of the Australian report:
   1. the system prepares children for reading through pre-reading activities such as drawing instructional entities and letters;
   2. the system is grounded in the concept of writing before reading and constitutes not only a reform but a paradigmatic reversal of philosophy that commences with the pre-school level of education;
   3. the system carries within itself and its exemplary methods step by step instruction so that working teachers and other instructors are constantly advised in the mechanisms of the teaching method;
   4. the system is evidence based on current research that is primarily neurologically focused;
   5. the system, by virtue of carrying within itself step by step instructions and updateable exemplary methods, provides working teachers and other instructors evidence based state of the art mechanisms for teaching the arts of writing and reading and thereby reduces the need and urgency for overhauling teacher training systems.

There is voluminous conclusive evidence that the beginning reader must have an awareness that words are composed of segmental elements, both graphic and acoustic. However, school age children often lack this fundamental knowledge. Devices and methods of instruction for pre-school children, as well as school aged children, that attempt to foster an awareness of the segmental graphic and acoustic elements of word composition, are generally well known in the art. However, in contrast to the present invention, none of the numerous inventions and patents currently available succeeds in teaching the arts of writing and reading as a complete integrated system that can be utilized from early childhood through high school and which incorporates the linguistic and artistic work product of the student as part of the content matter of instruction. For example:

sequencing toys such as those referenced in U.S. Pat. Nos. 6,607,388, 6,074,212, and 4,936,780, all issued to Mary Ann Cogliano, while combining sound and visual indicia, have no relevance to teaching writing and are limited to teaching only the names of letters and numerals;

puzzles such as referenced in U.S. Pat. No. 5,620,324 issued to Robert Rettke, and U.S. Pat. No. 5,575,658 issued to Craig Barnard, while offering cognitive stimulation, generally have no direct relevance to teaching writing or reading;

word games such as referenced in U.S. Pat. No. 6,450,499 issued to Henry Letang all assume the preexistence of writing and reading skills and are not designed to teach writing;

magnetic responsive drawing tablets are extremely limited in their applicability in that they generally provide nothing more than an easily erasable blank surface. U.S. Pat. No. 6,932,613 issued to Janice Olsen does include magnetic stamps to aid in letter formation, but they are limited to capital letters only;

electronic writing apparati such as referenced in U.S. Pat. No. 6,755,656 issued to Lenka Jelinek require viewing screens, key pads or other entry devices and do not generally provide the opportunity for individual constructive tactile input and neuronal stimulation appurtenant thereto. In addition, the sense of accomplishment and the cognitive attribution of ability to one's self is either diminished or eliminated.

color coding and pictorial systems such as referenced in U.S. Pat. No. 5,429,513 issued to Ruth Diaz-Plaza are complex and cumbersome and require learning properties unrelated to either writing or reading;

blocks such as referenced in U.S. Pat. No. 4,877,405 issued to Mark Stewart are useful for tactile properties but have extremely limited applicability in teaching writing or reading.

A classroom emphasis on phonological processes assumes that teachers have the requisite understanding of phonological awareness for effective teaching. Research indicates that many teachers themselves do not have a solid foundation in phonological awareness, and few have received the level of training appropriate for developing in children a fine grained sensitivity to the sound structure of words. (Published books purporting to teach phonics to children are known to contain errors. For example, one publisher indicates that the words “hot” and “dog” are to be pronounced with the same “o” sound, when this is actually an example of a regional dialect differing significantly from the majority pronunciation). Studies demonstrate that students whose teachers themselves have phonological deficiencies display lower levels of reading skills as a consequence. A device or method of instruction that strengthened the foundational skills of phonological awareness in teachers would be beneficial both to the teachers and to their students. The present invention, through its various teacher charts, teacher manuals and scripted lessons, is such a method.

In addition to growth in the body of knowledge concerning the value of early phonemic awareness is growth of new scientific research dealing with the neural basis of reading acquisition and the multiplicity of variables involved therewith. Initially, for example, a primary goal of cognitive psychology was to explore the way an individual collects, stores, modifies and interprets environmental information or information already stored internally. This approach generally excluded emotion, as emotion was generally considered a topic of investigation more appropriate for other disciplines of psychology such as personality. However, as our understanding of the neural basis of human cognition grows, it has become increasingly apparent that the neural circuitry of emotion and cognition interact from early perception to and through the decision making process.

Our understanding of the complexities of the inter-relational nature of emotion and cognition is continually developing. However, although studies have demonstrated that learning through direct personal experience is a powerful means of emotional learning and although we have developed our language into an efficient, symbolic means of communication that also allows for the acquisition of emotional properties of a stimulus without direct experience, we presently make little or no use of these capabilities in our language teaching methodologies. (See reference to William Tunmer wherein it is stated that training before reading instruction produces significant advantages in reading achievement, and that beginning readers must become active problem solvers with regard to graphic information, thereby developing self improving metacognitive strategies.) The present invention, however, is specifically designed to make advantageous use of learning through direct personal experience as well as acquisition, incorporation and utilization of emotional properties without direct experience.

It is also known that emotion enhances perception and potentiates the perceptual benefit of attention. Attention and perception are the first stages of stimulus processing, and factors that influence these early processes will also influence cognitive functions such as memory and reasoning. (See reference to Elizabeth Phelps). Furthermore, the importance of emotional salience in attention is well documented, and brain imaging studies have shown that attention leads to enhanced activation in visual processing regions of the brain. However, again, we presently make little or no use of these capabilities in our language teaching methodologies. As noted above, a device or method of instruction that introduced or enhanced emotional salience of the word learning processes in children would clearly be beneficial. The present invention is specifically designed to incorporate natural relevance and emotional salience in its method and to do so at an earlier age than any other currently available system.

The invention design is based on the principle of individuation, i.e., multiple students of mixed ages, capabilities, prior knowledge and prior experience can be taught individually by one teacher in a single classroom. The method is therefore utilizable in multiple settings ranging from: a single parent instructing a single child at home; to several children in a small preschool; to many children in larger preschools; to various numbers of children of various ages in various home school, pre-school and elementary school settings. In addition, the process, although basic and simplified for very young children below two years of age, can begin as early as a child is sufficiently prehensile to make any mark on a surface such as paper with an implement suitable for making marks such as a crayon.

During the process of becoming enabled to write, the child learns the sound names of all 26 majuscule letters, all 26 miniscule letters, all 10 numerals, and all 14 of the punctuation marks. In addition, the child learns to construct words from their segmental component parts, to properly pronounce the segmental components, and to read constructed words regardless of the order of presentation. As knowledge of the content matter is being developed, so too are various metacognitive skills including the ability to recognize errors, employ strategies for error correction, direct and focus attention, set goals and monitor progress.

One significant benefit of this early writing enablement in children is that both writing and reading are easier for a child to learn than the traditional reading-before-writing method. Because it is based on the individuated prior acquired skills of scribbling and drawing and therefore possesses a natural relevance for the child, the derived individuated skill of writing is not only more quickly learned but also more lastingly remembered by each student. (See reference to Professor Margot Prior, wherein it is stated that reading is a complex skill requiring many sub-skills, and the child needs to learn all of the sub-skills involved.) Consequently, reading, which in large part is the remembering of drawn symbols and the remembering of meaning attached to drawn symbols, is potentiated.

Another significant benefit is the better utilization of as many as five years of pre-elementary school life for development of literacy skills in the child. Very young children excel at making marks on paper, but that is not all. Very young children:
can understand that marks have meaning;
can understand that marks can make words;
can understand that words have meanings;
can remember the specific meanings attached or corresponding to specific marks, or series or marks;
can understand that marks can represent sounds;
can remember the specific sounds attached or corresponding to specific marks and words.
   Therefore, a child who can make a specific mark, or combination of marks, and who can remember the meaning attached to the marks, can read because reading is nothing more than that: remembering the meaning attached to marks.

A third significant benefit is the early introduction of orthographic word construction from segmental components to the conscious mind of the child, a process with which the child is already familiar in its phonological form, perhaps even on a subconscious level, since birth.

A fourth significant benefit is that while the child is learning to construct words from segmental component parts, the child is simultaneously enabled to read what he or she has written.

Still other benefits include, but are not limited to: the mutual enhancement through reinforcement of the conscious and subconscious components of word segmentation and construction; the enhancement of, or introduction of, emotional salience to the word learning process; and the extension of time the window of opportunity for language acquisition and development may be open.

In the process of acquiring a spoken language, an infant child begins to learn to select individual sounds from continuous speech signals and to recognize them as distinct from the many sound patterns already stored in memory. The child also learns to reproduce the sound patterns in a way that makes them recognizable both to itself and its listening partners. The language acquisition process may therefore be described as a mapping process whereby the child is enabled to bridge from reception of a complex acoustic pattern produced by a voice outside of the child to a complex motor control program within the child that reproduces the pattern using the child's own voice. The key to success in this very early stage of the child's literate life is segmentation into smaller components, and a device or method which enables or enhances the developing segmentation abilities of the child would clearly be beneficial. The present invention is specifically designed to enable and enhance segmentation abilities in children and to do so in a different manner and at an earlier age than any other currently available system

To grow from an approximate average of 50 words at 18 months to between 500 and 1500 words at 36 months, the young child must acquire at least one or two new words per day. It would be impossible to account for this rapid vocabulary growth without positing that the child has acquired an implicit phonological grammar with which to index and database segmented sublexical patterns on both sides of the bridge and to access words and patterns that are already known to the child. Here again, the key to success is segmentation into smaller segmental components that empower the child to abstract a symbolic representation of deconstructed sound forms of words into smaller sublexical patterns.

Learning to read follows a similar pattern. Minimally, the bare essentials of reading are a set of external symbols that represent words of the language which, in order to be understood and verbalized, need to be separated from continuous text streams and mentally represented and connected to corresponding items in a mental lexicon. Again, segmentation is the key, and as previously noted, the present invention is specifically designed to enable and enhance segmentation abilities in children and to do so in a different manner and at an earlier age than any other currently available system.

Every school child starts with two such mental lexicons: one storing the meanings of words, known as the semantic lexicon, and one storing the sound forms of words, called the phonological lexicon. (See reference to Franck Ramus wherein it is stated that orthographic symbols need to be connected with the corresponding items in the phonologic and semantic lexicons.) Then, internally, representation of the set of printed symbols requires the creation of a third lexicon, the orthographic lexicon, and these new representations of the orthographic lexicon must be connected with the corresponding items in the semantic and phonological lexicons.

Just as the phonological representations are combinatorial, being made of smaller units that include phonemes, the printed symbols are themselves combinations of smaller units, the letters of the alphabet, called graphemes. While this triumvirate of lexiconic neurological encodings can be viewed simply as the translation from print that forms a code from which the reader can derive meaning, ultimately the key to the neurological encodings is segmentation into smaller components.

There are many synonyms or near synonyms for the term ‘phonological awareness’ such as: phonemic awareness, phonetic awareness, acoustic awareness, phonemic segmentation, phonological sensitivity, phonemic sensitivity and others. It is clear that all of these terms are intended not to deal with the meaning of words but to deal with the construction of words from segmental elements.

Studies show that children's level of phonological awareness, i.e., the ability to segment spoken words into segmental components, before they begin reading instruction predicts their later reading achievement better than any other measure. A burgeoning consensus now exists concerning the critical importance of phonological awareness to beginning reading success and reading disability as well. However, the majority of current reading skill training methods that place primary emphasis on phonological awareness simultaneously stress only an awareness that words may be broken down or segmented into sets of sound units. In contrast, the present invention emphasizes phonological synthesis and stresses an awareness that words are built up from their separate constituent smaller parts, thereby doubling the number of phonological awareness teaching tools available to the instructor.

In the year 2000, the National Reading Panel issued a report based on its own review of more than 100,000 high quality, peer reviewed studies (See Neuman, Susan B.), in response to a U.S. Congressional mandate to help parents, teachers and policy makers to identify key skills and methods central to reading achievement. That both a Congressional mandate was issued and that 100,000 high quality studies were extant regarding reading instruction gives a clear indication if not a clear picture of what needs of the nation are not being met. We have placed a man on the moon, sent a rover to mars, and drafted deep space messages statedly decodable and readable by any entity capable of receiving them. And yet, our teachers struggle to teach, and our children struggle to read. Why? There may be a hint of an answer in one deep space message designed by University of California astrophysics professor Frank Drake containing a stick figure composed entirely of only two orthographic patterns: a straight line (|) and a circle (◯). The present invention is based on the same stick figure and the same straight line (|) and a circle (◯). Another hint may be found in a 1999 paper prepared for the American federation of Teachers by Louisa C. Moats, project director, Washington D.C. site of the National Institute of Child Health and Human Development (NICHD) Early Intervention Project where it is stated, (and the paper is entitled), Teaching Reading Is Rocket Science.

This invention takes into account all of the considerations described above and all of the elements of reading, writing and language acquisition described previously in this background synopsis. In all specified problematic areas, an improvement has been provided by this invention. However, in addition to improving problematic areas in the current and prior art, the present invention offers additional benefits and improvements to the general state of art of reading and writing instruction to young children by incorporating the child's own self produced art into the teaching and learning process and encouraging the creative activities necessary to produce that art, thereby potentiating focus and interest on the part of the child and expanding centers of neuronal activity in the brain.

Specific references to known US patents evidencing relevance to the present invention either by similarity or dissimilarity are:
U.S. Pat. No. 7,217,135 May 15, 2007 Marcus, Brian Discloses a contact sensitive screen educational toy capable of executing software. U.S. Pat. No. 7,217,135 is not relevant to teaching writing.
U.S. Pat. No. 7,217,132 May 15, 2007 Knepper, Tory Discloses a medium for teaching children to recognize objects including shapes, forms and numbers on a sheet especially where tactile material forms part of the objects. U.S. Pat. No. 7,217,132 is not relevant to teaching writing.
U.S. Pat. No. 7,098,919 Aug. 29, 2006 Kim, Hyo-Jin Discloses an alphabetic character key pad input device utilizing half strokes of certain alphabetic characters. The primary purpose of this invention is to reduce from three to two the number of entries required to input alphanumeric characters into an electronic device such as a cellular telephone. U.S. Pat. No. 7,098,919 is not intended to simplify writing instruction or to teach writing or reading.
U.S. Pat. No. 7,080,983 Jul. 25, 2006 Barker, Kenneth Discloses a flipbook device for teaching about the structure of written words using color coded sets of pages imprinted with a letter or letter cluster. States that a flipbook “affords both compactness and is less prone to having individual pieces lost . . . can demonstrate that different letters or letter clusters can be substituted for each other within words, by rotating pages . . . ” U.S. Pat. No. 7,080,983 emphasizes color coding and is primarily a portable visual device that highlights relationships of letters.
U.S. Pat. No. 7,063,535 Jul. 20, 2006 Stamm, Jill Discloses a system and method for stimulating early childhood brain development consisting of a box, a mat and printed activity cards describing activities that may build skills related to a child's future learning potential and readiness for formal education. U.S. Pat. No. 7,063,535 is not directly related to teaching reading or writing skills, but is related to development of emotional states and emotional salience of subject matter.
U.S. Pat. No. 6,932,613 Aug. 23, 2005 Olsen, Janice Discloses a magnetic responsive drawing tablet and stamps for use as a pre-writing teaching aid. For use with capital letters only.
U.S. Pat. No. 6,755,656 Jun. 29, 2004 Jelinek, Lenka Discloses an electronic writing device consisting of a light beam that temporarily illuminates a portion of a screen to guide a user through proper handwriting techniques. U.S. Pat. No. 6,755,656 is impractical for utilization by children and does not incorporate sound, word meaning, or word construction.
U.S. Pat. No. 6,607,388 Aug. 19, 2003 Cogliano, Mary Discloses an educational toy for teaching a sequence of letters and numbers. Includes sound initiated by a pressure sensitive switch. U.S. Pat. No. 6,607,388 is useful for sequence instruction, but it is not applicable for writing or reading instruction.
U.S. Pat. No. 6,585,517 Jul. 1, 2003 Wasowicz, Janet Discloses a computer based phonological awareness and reading skill training system utilizing various graphical games. States that “the problem is that it is difficult for untrained teacher's to train . . . ” U.S. Pat. No. 6,585,517 is not intended for writing instruction.
U.S. Pat. No. 6,468,084 Oct. 22, 2002 MacMillan, Philip Discloses a voice recording and playback system for teaching multiple parts of a language. States “what is needed, then, is an efficient learning technique to assist a range of individuals who are experiencing difficulties . . . ” U.S. Pat. No. 6,468,084 is primarily intended as a remedial system.
U.S. Pat. No. 6,450,499 Sep. 17, 2002 Letang, Henry Discloses a word game. U.S. Pat. No. 6,450,499 is not intended to teach writing, It may have limited application as an aid to learning reading.
U.S. Pat. No. 6,302,696 Oct. 16, 2001 O'Neill, Nancy Discloses a bi-colored instructional writing paper couple with a method for instructing children to write letters. The method of instruction contained in U.S. Pat. No. 6,302,696 appears to be limited to providing a verbal cue calling upon the student to draw a letter that “reaches for the sky” or that “sits on the grass”. This patent does not disclose any additional method of teaching letter formation other than these two verbal cues.
U.S. Pat. No. 5,429,513 Jul. 4, 1995 Diaz-Plaza, Ruth Discloses a portable apparatus for displaying color coded graphemes on the surface of a board together with a sound pattern generating device. U.S. Pat. No. 5,429,513 emphasizes aural reinforcement of similarities and differences between color coded graphemes through use of individually activated sound generating devices. U.S. Pat. No. 5,429,513 is complex, cumbersome and impractical for use as a viable tool for teaching children to write.
U.S. Pat. No. 6,299,452 Jul. 9, 1999 Wasowicz, Janet Discloses a computer based diagnostic system for determining whether an individual being tested is at risk for having reading problems. States “both analysis and synthesis skills have been identified as important prerequisites for achieving the goal of early reading skill proficiency . . . ” U.S. Pat. No. 6,299,452 is a diagnostic tool for identifying individuals, primarily children in kindergarten through second grade, who are likely to experience academic failure due to deficits in reading skills. Not applicable to teaching writing.
U.S. Pat. No. 4,669,986 Jun. 2, 1987 Yokoyama, Yoshimasa Discloses a writing training device consisting of a stencil for guiding letter formation with grooves. U.S. Pat. No. 4,669,986 has no applicability to teaching the art of reading.
U.S. Pat. No. 4,650,423 Mar. 17, 1987 Sprague, Robert Discloses a periodic code of forty five language elements similar to a chemical periodic table. The periodicity of the elements is described in terms of articulation mechanisms. Photographs of mouth pattern and voice frequency information are provided for each language element. U.S. Pat. No. 4,650,423 is complex and not practical for use with small children
Patent Application 20060046232 Friedman, Mark Discloses a method for acquiring language skills through utilization of a visual display attached to a mother's or caregiver's chest. Claims to “provide the child with the ability to read as a byproduct of this environment”. Also claims to include writing skills.

General references to known research, publications and/or teaching systems referenced by this review of the state of technology and prior art as described above are:
Ramus, Franck. (2004). The Neural Basis of Reading Acquisition. In M. S. Gazzniga (Ed.), The Cognitive Neurosciences (3 ed.), (pp. 815-824), Cambridge, Mass.: MIT Press.
Phan, K. L., Taylor S. F., Welsh, R. C., Ho, S. H., Britton, J. C., Liberzon, I. (2004) Neural correlates of individual ratings of emotional salience: a trial related fMRI study. Neurimage 21(2): (pp. 768-780).
Brown, A., Robinson, A., Herbert, J. S., Pascalis, O. (2006) Age and emotional salience of stimuli alter the expression of visual recognition memory. In Current Psychology Letters, 20, Vol. 3.
Gorman, J. C., (1999) Understanding Children's Hearts and Minds: Emotional Functioning and Learning Disabilities. www.LDOnline.org/article/6292
Prior, Professor Margot (2006) Why Phonics. On ABC Radio National. Typed Transcript. www.abc.com.au/rn/linguafranca/stories/2006/1560803.htm
Tunmer, William E. (1999) Science Can Inform Educational Practice: The Case of Literacy. 1999 Herbison Lecture. AARE-NZARE joint conference. www.aare.edu.au/99pap/tun99777.htm
Ritchey, K. D., (2006) From letter names to word reading: The nascent role of sublexical fluency. Contemporary Educational Psychology, Vol. 31, No. 3 (pp. 301-327).
Beckman, M. E. (2001) Effects of sublexical pattern frequency on production accuracy in young children. CLSP Seminar Series. www.clsp.jhu.edu/seminars/abstracts/S2001/mary_beckman/index.shtml
Shillcock, R. C., Monaghan, P. (2004) Reading, Sublexical Units and Scrambled Words: Capturing Human Data. Work supported by The Wellcome Trust and by the Economic and Social Research Council (UK). www-users.york.ac.uk/˜pjm21/papers/scrambledwords.pdf
Phelps, E. A. (2006) Emotion and Cognition: Insights from Studies of the Human Amygdala. Annu. Rev. Psychol. www.arjournals.annualreview.org by NEW YORK UNIVERSITY—BOBST LIBRARY.
Ikeguchi, C. B. (1997) Teaching Integrated Writing Skills. International Journal for Teachers of Writing Skills. January 1997. Also, The Internet TESL Journal, vol iii, No. 3, March 1997
Aram, D., Korat, O., Levin, I. (2005) Maternal Mediation in a Young Child's Writing Activity: a Sociological Perspective. www.scriptil.org/upload/aramandkoratandlevin.pdf
Ruden, Ronald A. (2003) The Craving Brain. Harper Collins, publisher.
Motluk, Alison (2005) Senses special: The art of seeing without sight. New Scientist. Pg. 37. Issue 2484, Jan. 29, 2005.
Neuman, Susan B. (2001) Citing reference to 100,000 studies. http://www.nifl.gov/partnershipforreading/publications/reading_first_print.html
US House Report 105/348 http://www.congress.gov/cgi-bin/cpqueary/R?cp105:FLD010:@1(hr348)
National Institute For Literacy Accomplishments Report FY 1993-2002 (2004) http://www.nifl.gov/nifl/publications/accomplish.pdf
National Institute of Child Health and Human Development (2000). Report of the national reading panel: Teaching children to read—an evidence-based assessment of the scientific research literature on reading and its implications for reading instruction. (NIH Publication No. 00-4769). Washington D.C.: U.S. Government Printing Office. http://www.nichd.nih.gov/publications/nrp/smallbook.htm
McNeill, D. (2005). Gesture and thought. Chicago & London: University of Chicago Press.
Philps, D. (2006) From Mouth to Hand, Department of English, University of Toulouse-Le-Mirail, France, http://www.tech.plym.ac.uk/socce/evolang6/philps.doc
Corballis, M (2003) From hand to mouth: the gestural origins of language. In M. H. Christiansen & S. Kirby (Eds.), Language evolution (pp 201-218). Oxford: Oxford University Press.
MacNeilage, P. F. (19XX). The Frame/Content Theory of Evolution of Speech Production. Unedited penultimate draft of: Behavioral and Brain Sciences, XX (X): XXX-XXX. http://bbsonline.cup.cam.ac.uk/Preprints/OldArchive/bbs.macneilage.html
Louisa C. Moats (1999) Teaching Reading Is Rocket Science, Washington D.C., National Institute of Child Health and Human Development (NICHD) http://www.aft.org/pubs-reports/downloads/teachers/rocketsci.pdf
RE: pronunciation of the words “hot” and “dog”, see: Book 1A, dod the dog, http://www.progressivephonics.com
RE: a teaching method incorporating writing and reading, see: Spalding, Romalda Bishop (2003) The Writing Road to Reading, 5 Edition, HarperCollins Publishers Inc.

### BRIEF SUMMARY OF THE INVENTION

In its entirety, the present invention constitutes a system wherein is provided to an instructor certain pragmatic methods, materials and instructions for teaching the arts of writing and reading commencing with persons aged one year and older who are capable of making primitive childhood art, receiving and participating in multi sensory instruction, and learning. Nearly all neurologically and physically unimpaired children meet this minimal capability requirement.

Ten elements of the system 100 are considered the key or major elements comprising the invention which are in turn supported and enhanced by several other components which include parental involvement and externally integrated materials such as books written to correspond with the primary materials of the system. The ten major elements of a full working embodiment of the system are:
1. orthographic patterns called graphemic segmental strokes;
2. grapholinear sketches of scenes and characters called instructional entities composed entirely of graphemic segmental strokes;
3. elicitation frame forms used to model graphemic segmental strokes, graphemes, words and sentences and to provide practice space in close proximity to the models;
4. a framework of instructional materials called a chart of expectations;
5. instructor guided sequentially preferred interactions of the instructor with the student and instructional materials;
6. direct personal experience of the student with the instructional materials developed through a sequence of natural relevance and self interest;
7. a plurality of levels of instructional materials for establishing, measuring and maintaining accomplished goals by students;
8. individuation by virtue of a method and capability to simultaneously teach different lessons in the same classroom to individual students plus the related concepts of individuated foundational readiness, or “IFR”, and the point of commencement of struggle, or “pocos”, that provides graphic notice to an observing instructor of a point of beginning of decline in accomplishment by a student;
9. a registration chart enabling the instructor to accomplish individuated instruction. The registration chart also provides visual establishment and confirmation of points of commencement of struggle when and where they exist. The registration chart further provides notice to the instructor that a student has successfully completed a prescribed level of endeavor and indicates that a reward in the form of a certificate of accomplishment should be issued to the student; and
10. a “learning-to-learn” sub-skill development philosophy designed to foster general metacognitive skills emphasizing attention control, goal setting, self evaluation and self regulation.

The present invention identifies twelve orthographic patterns of which at least one, and typically more than one, is essential to the construction of any and all graphemes which in turn are the minimal components of written language. These patterns, referred to within the invention as graphemic segmental strokes, constitute the atomic particles of writing and are locatable and distinguishable within the markings and scribblings of small children as well as adults. Therefore, the ability to selectively draw the graphemic segmental strokes constitutes a fundamental enabling skill with which children can begin to communicate as early as age two.

Capitalizing on a nearly insatiable drive for knowledge and experiences in all normally functioning young children, the invention provides methods, materials and instructions enabling instructors to provide children with fascinating mental stimulation in a playful context. In addition, the same methods and materials enable a child to define, materialize and externalize both their innate and acquired tacit knowledge by selecting, guiding and enhancing their abilities to make orthographic pattern marks. In turn, these purposeful manipulations of the orthographic pattern marks constitute self improving metacognitive problem solving strategies intimately connecting and potentiating the writing, reading and comprehension skills of the child.

The invention demonstrates that the ability to read is not a precondition for developing the ability to write in children. Furthermore, when reading is taught first, reading and writing are basically two unrelated skills taught at separate times. In addition, when reading is taught first, the reading process becomes one of word de-construction and phonological analysis. When writing is taught first, the two skills of reading and writing are closely related and are acquired nearly simultaneously. In addition, the reading process is one of word construction and phonological synthesis. The significance of the difference between analysis and synthesis may be shown by a simple analogy: one can more easily learn to build a house by actually building a house than by first deconstructing a house and then attempting to reconstruct the house from its parts.

In one exemplary embodiment, the system commences with the display to young or pre-school students of a grapholinear (stick) figure composed entirely of graphemic segmental strokes. The instructor proceeds to model the drawing of the grapholinear figure and encourages the students to do the same. The strokes required to draw the figure are specifically and exactly the same strokes required to draw (write) all of the letters, numbers and punctuation marks of the English language. The present invention systematically demonstrates the strokes in a programmed series method that enables the student to convert what would otherwise be incomprehensible marks and scribbles initially into letters and subsequently into words and sentences complete with punctuation marks.

In an advanced exemplary embodiment, the system focuses on building basic written vocabulary and utilization of the basic written vocabulary by elementary school age students to construct sentences.

In another advanced exemplary embodiment, the system focuses on building advanced written vocabulary and utilization of the advanced written vocabulary by elementary and high school age students to construct improved sentences and paragraphs.

The present invention may most simply be described as a system and method for enabling children to learn to write before learning to read. However, since the present invention is not limited in its applicability to pre-school or young children in general, it would be appropriate to more explicitly describe the present invention as an integrated, individuated, written, read and vocalized alphabetic language development and comprehension teaching method and system that facilitates teaching the art of writing to individuals commencing with children aged one year and older who are thereby enabled to write, read, speak and comprehend what they have written. In summary:

it is an object of this invention to introduce a writing method to children at an earlier age than other methods;

it is an object of this invention that its methods follow a sequence of natural relevance for the child;

it is an object of this invention that its subject matter sequencing elevates the degree of interest of the child in the subject matter;

it is a further object of this invention to enable a child to begin to write and thereby simultaneously begin to read;

it is a further object of this invention to provide instant feedback to the learner in an emotionally salient, confidence building, failure free environment;

it is a further object of this invention to provide a coordinated algorithmic method throughout to ensure proper sequencing within the system;

it is a further object of this invention to provide improvements, corrections and solutions to the numerous stated problematic areas in the current teaching systems and prior art;

it is a further object of this invention to teach the primary skills of writing and reading in such a manner as to develop a “learning-to-learn” sub-skill designed to foster general metacognitive skills emphasizing attention control, goal setting, self evaluation and self regulation of learning in the student.

### BRIEF DESCRIPTION OF THE DRAWINGS

FIG. 1 is a chart illustrating an exemplary system for facilitating teaching the arts of writing and reading to persons capable of being so taught commencing approximately at the age of one year or older;

FIG. 2 is a chart depicting 12 essential components and subcomponents of grapheme and word construction;

FIG. 3 presents a chart of the lessons to be presented in Level One which constitutes the expectations of the Level and a brief summary of the projected accomplishments upon completion of the lessons contained in the Level;

FIG. 4 depicts a complete sketch of instructional entity 1 named Alphie comprised entirely of the graphemic segmental strokes depicted in FIG. 2;

FIG. 5 depicts the first step of eight exemplary instructional steps in drawing the grapholinear (stick) figure named Alphie.

FIG. 6 depicts the second step of eight exemplary instructional steps in drawing the grapholinear (stick) figure named Alphie.

FIG. 7 depicts the third step of eight exemplary instructional steps in drawing the grapholinear (stick) figure named Alphie.

FIG. 8 depicts the fourth step of eight exemplary instructional steps in drawing the grapholinear (stick) figure named Alphie.

FIG. 9 depicts the fifth step of eight exemplary instructional steps in drawing the grapholinear (stick) figure named Alphie.

FIG. 10 depicts the sixth step of eight exemplary instructional steps in drawing the grapholinear (stick) figure named Alphie.

FIG. 11 depicts the seventh step of eight exemplary instructional steps in drawing the grapholinear (stick) figure named Alphie.

FIG. 12 depicts the eighth step of eight exemplary instructional steps in drawing the grapholinear (stick) figure named Alphie.

FIG. 13 depicts a sketch of Instructional Entity 2, a fictional character named Boxie Big Jaw.

FIG. 14 depicts a sketch of Instructional Entity 3, Alphie's house.

FIG. 15 depicts Style 1 of an exemplary Elicitation Frame Form;

FIG. 16 depicts Style 2 of an exemplary Elicitation Frame Form;

FIG. 17 depicts Style 3 of an exemplary Elicitation Frame Form;

FIG. 18 presents an exemplary first lesson as contained in the Level One Manual;

FIG. 19 presents an exemplary second lesson as contained in the Level One Manual;

FIG. 20 presents an exemplary third lesson as contained in the Level One Manual;

FIG. 21 presents an exemplary fourth lesson as contained in the Level One Manual;

FIG. 22 presents an exemplary fifth lesson as contained in the Level One Manual;

FIG. 23 presents an exemplary sixth lesson as contained in the Level One Manual;

FIG. 24 presents an exemplary seventh lesson as contained in the Level One Manual;

FIG. 25 presents an exemplary eighth lesson as contained in the Level One Manual;

FIG. 26 presents an exemplary ninth lesson as contained in the Level One Manual;

FIG. 27 presents an exemplary tenth lesson as contained in the Level One Manual;

FIG. 28 presents an exemplary eleventh lesson as contained in the Level One Manual;

FIG. 29 presents an exemplary twelfth lesson as contained in the Level One Manual;

FIG. 30 presents an exemplary thirteenth lesson as contained in the Level One Manual;

FIG. 31 presents an exemplary fourteenth lesson as contained in the Level One Manual;

FIG. 32 presents an exemplary fifteenth lesson as contained in the Level One Manual;

FIG. 33 presents a chart of all of the grapheme constructions developed and utilized during Level One;

FIG. 34 presents a chart of all of the numeric grapheme constructions utilized in construction of the ten numerals;

FIG. 35 presents an exemplary registration chart;

FIG. 36 presents a system summation chart;

FIG. 37 presents a system algorithm chart.

FIG. 38 presents a graphic description of a human learning algorithm portraying basic mental pathways ranging from stimulus to response.

FIG. 39 presents a graphic description of a circuitous or spiraling metacognital learning and transfer of learning progression.

### DETAILED DESCRIPTION OF THE INVENTION

The following description makes reference to the accompanying drawings which are shown by way of illustration and not of limitation. Changes may be made for purposes of enhancement or clarification without departing from the spirit and scope of the invention. Similarly, this detailed description is presented for purposes of illustration only and not of limitation, as the scope of the invention is defined solely by its claims.

Preliminarily, a short glossary is inserted here to clarify and specify the intended meaning of words and terms as they are used herein:

“alogrithmic” means of or related to an algorithm, which in turn means a finite list of well-defined instructions for accomplishing some task that, given an initial state, will terminate in a defined end-state.

“art” means any arrangement or production of one or more lines or forms, with or without color, in any combination, made with or without intent of the artist.

“classroom” means any place where instruction can occur, including a formal classroom, but also including a private room in a home, or similar suitable space.

“cognitive ownership” means a condition wherein a skill or information is learned well enough to be recallable and utilizable on demand in known situations and is also transferable for application in novel situations.

“elicitation frame” means a device, usually printed, that helps to constrain and control what is elicited by providing a fixed environment used to present, model, test, practice, discover, and otherwise manipulate graphemic segmental strokes, graphemes, words and sentences.

“exemplary manual” means a manual physically presented in its entirety within this document.

“graphemic segmental stroke” means any of the orthographic patterns described and depicted by the system as being component parts of a grapheme such as, but not limited to, the two angled strokes and one cross stroke contained in the letter A, or either the vertical stroke or the horizontal stroke in the T, or the entire circular stroke of the letter O, or the entire curved stroke of the letter U, or the four strokes required to produce the letter E.

“grapholinear sketch” has the same meaning as “instructional entity”.

“IFR” is an acronym that refers to individuated foundational readiness.

“individuated” means personalized, being or having become separated or distinct from a group or class.

“individuated foundational readiness” means a condition of ability and readiness to proceed to a next succeeding lesson or level of instruction achieved by an individual student, as distinguished from a group or class, after successfully completing prior lessons or levels of instruction.

“instructional entity” means any drawing composed entirely of graphemic segmental strokes and may include, but is not limited to, a single stylized anthropic character, a house surrounded by trees and clouds, an imaginary dinosaur character, other scenes, animals and characters, and so on.

“instructor” includes any natural person capable of providing instruction to a student in accordance with the directions and instructions provided by the system and includes, but is not limited to, parents, teachers, students and caregivers. The term “instructor” also means and includes any non-living entity capable of containing and providing instructional information to a student in accordance with the directions and instructions provided by the system and includes, but is not limited to, computers and similar electronic devices, books and similar printed items, toys and similar mechanical devices, televisions and similar communication devices, and recording or playback devices such as tape recorders, cd and dvd devices, and the like.

“linguistic effort” means any word or words or any combination of words intended by the author to communicate meaning, or purpose, or information more than would be contained in a mere list of the same words.

“Metacognitive” means awareness of the process of learning. It consists of two basic processes occurring simultaneously: monitoring your own progress as you learn, and making changes to your learning strategies when you deem it beneficial.

“pocos” is an acronym that refers to the point of commencement of struggle.

“point of commencement of struggle” means a point in time occurring along a continuum of instruction at which a student experiences difficulty with a particular task and before which the student had previously achieved successful completion of all tasks. At the point of commencement of struggle, both the instructor and student are expected to make the appropriate investment of time and effort required to enable the student to master the task in question. A student may encounter many such points of commencement of struggle during a programmed series of instruction. However, each point must be eliminated before the student is deemed to have achieved a condition of ability to proceed to the next proceeding lesson or level of instruction.

“referenced manual” means a manual for use within the system which is not physically reproduced within this document but exists external to this document and is part of the method and system of the present invention.

“situation elicitation frame” means a fixed environment used to present, model, test, practice, discover, and otherwise manipulate what is elicited.

“student” includes any person regardless of age capable of receiving instruction and productively participating in an interactive learning environment.

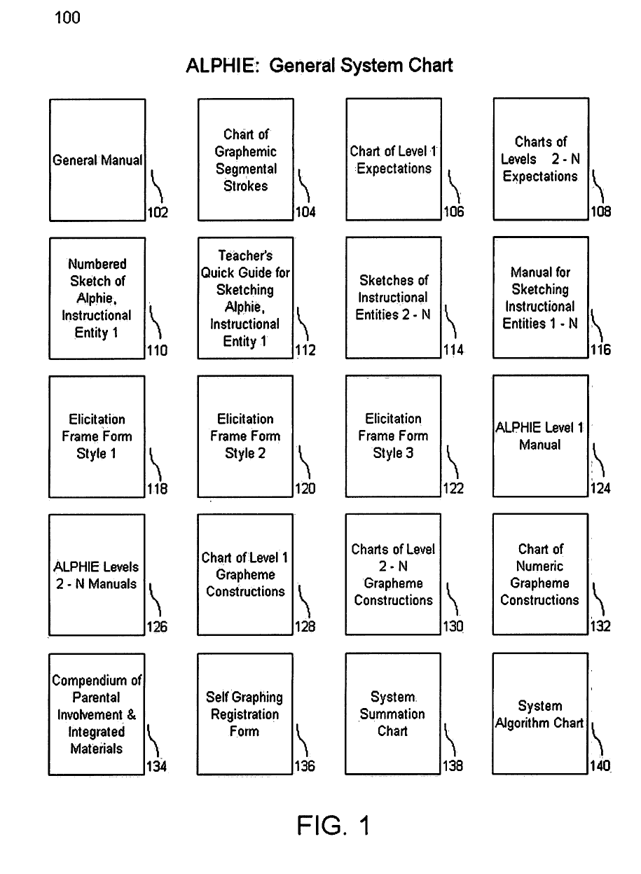

FIG. 1 (entitled ALPHIE: General System Chart) graphically illustrates the elements comprising an exemplary system 100 facilitating teaching the arts of writing, reading and comprehension of what has been written in accordance with the invention. The various elements of the system 100 are designed to provide instructors with the skills, methods, materials and assistance that are needed by an instructor to accomplish the purposes of the invention. Before commencing instruction of a student, an instructor should become familiar with the various elements of the system 100 by reading and reviewing the general manual 102 in its entirety. As illustrated in FIG. 1, an exemplary system 100 is comprised of:

a general manual 102 containing and comprised of all other manuals and materials referenced in FIG. 1;

a chart 104 of graphemic segmental strokes, eleven of which strokes may be considered as conventional orthographic straight lines and curved lines, and one of which strokes is comprised of a single dot.

a second chart 106 describing and defining the goals and expectations of Level One of the system 100;

additional charts 108 describing and defining the various goals and expectations of levels beyond Level One of the system 100;

a numbered sketch 110 of ALPHIE, the instructional entity after whom the present invention is named, wherein each numbered line refers to a specific graphemic segmental stroke 104;

a Teacher's Quick Guide 112 for sketching ALPHIE that includes exemplary script and advice to instructors regarding particular words suggested for vocal communications with students during the drawing process;

additional sketches 114 of instructional entities other than ALPHIE;

a manual 116 for sketching all instructional entities;

an elicitational frame form 118 of an exemplary style;

a second elicitation frame form 120 of a second exemplary style;

a third elicitation frame form 122 of a third exemplary style;

a manual 124 specifically for use with Level One of the system 100;

additional manuals 126 for use with levels beyond Level One of the system 100;

a chart 128 of the various grapheme constructions taught and practiced in Level One of the system 100;

a chart 130 of the various grapheme constructions taught and practiced in Levels beyond Level One of the system 100;

a chart 132 depicting ten numeric grapheme constructions and the methods for their construction ranging from zero to nine;

a compendium 134 of the various materials incorporating parental involvement in the system 100 including an index to research in the fields relating to this invention;

a self charting registration and progress chart 136;

a system summation chart 138; and

a chart depicting the algorithmic method of the system 100.

It should be noted that elicitation frame form Style One 118, elicitation frame form Style Two 120, elicitation frame form Style Three 122, together with their various respective manuals 126, will be discussed in more detail subsequently hereinafter.

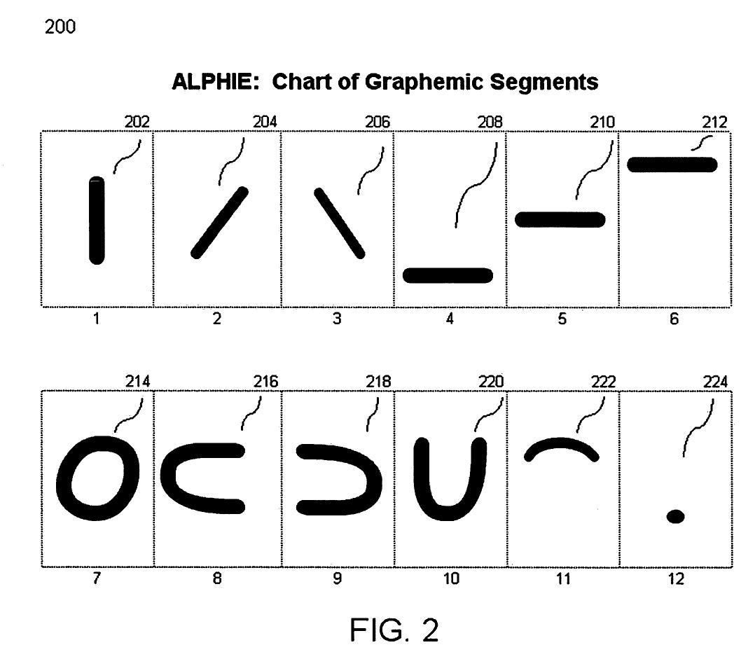

FIG. 2 depicts twelve orthographic patterns 200 of which at least one, and typically more than one, is essential to the construction of any and all graphemes which in turn are the minimal components of language. These patterns are referred to within the invention as graphemic segmental strokes 200 and they constitute the atomic particles of writing that are locatable and distinguishable within the markings and scribblings of small children and the writings of adults as well. The strokes 200 are specifically and exactly the same strokes required to draw or write all of the majuscule and miniscule letters, numbers and punctuation marks of the English language.

The orthographic patterns 200 depicted in FIG. 2 consist of: one vertical straight line 202 creating a 90 degree angle with the horizontal axis; one straight line 204 creating an angle which may approximate a 45 degree angle with the horizontal axis but which may in usage be greater or less than 45 degrees; one straight line 206 creating an angle which may approximate a 45 degree angle with the vertical axis but which may in usage be greater or less than 45 degrees; one straight line running horizontally 208 in lower relation to a second straight line running horizontally 210 in a median position relative to a third horizontally running straight line 212 and the low straight line 208 running horizontally; one circular pattern 214; one semi circular pattern 216 drawn from the top right running leftward; one semi circular pattern 218 running from the top left running rightward; one “U” shaped pattern 220; one quarter circular pattern drawn from the left with a centered apogee 222; and one dot 224 which is neither a straight line nor a curve.

It is the contention of the inventor that anyone who can be taught to make the orthographic marks 200 referred to herein as graphemic segmental strokes 200 is capable of being taught to write or draw any of the twenty six majuscule and miniscule letters, ten numbers and all punctuation marks of the English language. Consequently, by being enabled to write the various letters of the alphabet, students can be taught to write the various letters in correspondence with the sounds they represent and thereby construct words. It is a further contention of the inventor that the construction of words by students invests the student with a cognitive ownership of the word constructed, thereby potentiating recognition, recall and appropriate use of the word in context.

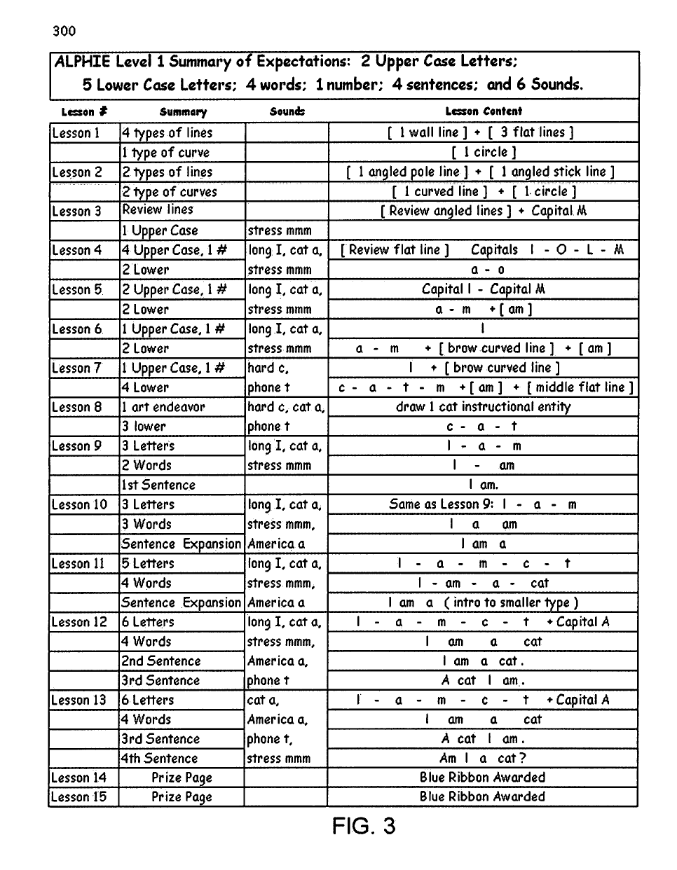

FIG. 3 depicts an exemplary Level One embodiment of the system 100 organized in a series of lessons 300 designed to provide a practical implementation of interactive sessions between a student and instructor. Further generally depicted in FIG. 3 is a framework for the presentation of Level One of the multi level system 100 as well as a structured means of guiding instructors in sequentially preferred interactions with students. As described in this embodiment 300, the system 100 summarizes projected accomplishments and facilitates interactive sessions that target specific aspects of writing ranging from the formation of orthographic patterns 104 referred to within the system 100 as graphemic segmental strokes 104 to construction of complete graphemes, words and sentences that comprise the projected accomplishments.

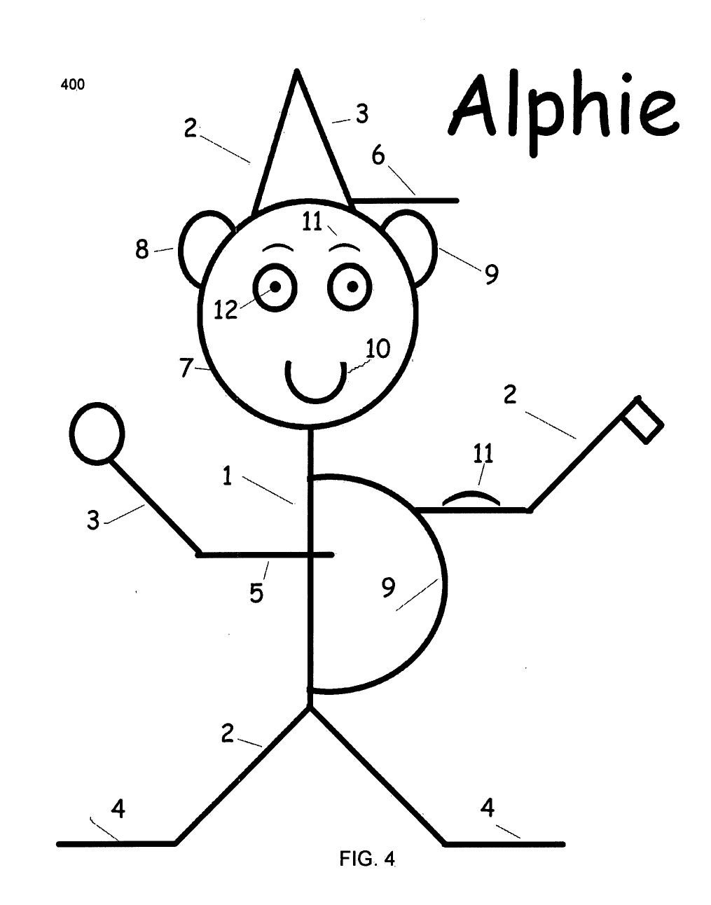

FIG. 4 depicts an exemplary version of ALPHIE, a grapholinear (stick) figure composed entirely of graphemic segmental strokes 200. The strokes required to draw the figure are specifically and exactly the same strokes required to draw (write) all of the letters, numbers and punctuation marks of the English language. The present invention systematically demonstrates the strokes 200 in a programmed series method commencing with an instructor modeling drawing ALPHIE 400 for observing students who are encouraged by the instructor to duplicate the series of steps required to produce their own versions of ALPHIE 400. It is the contention of the inventor that anyone of any age who is possessed of sufficient manual prehensile capability and dexterity who can be taught to make the orthographic marks 200 referred to herein as graphemic segmental strokes 200 that comprise the ALPHIE 400 grapholinear (stick) figure can also be taught to write or draw any of the twenty six majuscule and miniscule letters, ten numbers and fourteen punctuation marks of the English language. The strokes required to draw the figure have been numbered so as to provide identification and reference to the strokes 200 previously referred to in FIG. 2.

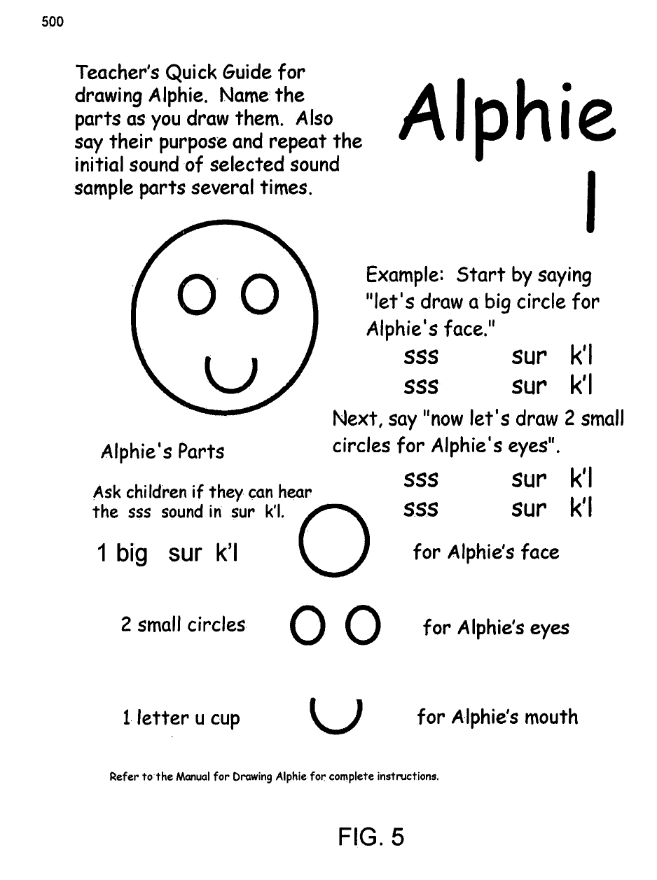

Numerous studies indicate that children actively search their surroundings for and fixate upon objects that have a high degree of contrast, have interesting contours, present complex patterns and have symmetrical designs. In addition, these studies note that designs of a circular nature are especially attractive to children. These characteristics all apply to the human face in general and to the grapholinear figure named Alphie drawn in FIG. 5 through FIG. 12 in particular.

Research further indicates that children's earliest involvement with storybooks is not centered on story aspects but upon merely attending to pictures in the form of looking at the pictures and making comments about them. The system 100 commences with the presentation to young students of a picture 400 and proceeds to instruct the student in the manner of constructing their own version of the picture 400. Both the visual action of observing a picture and the kinesthetic acts of constructing a picture produce pleasurable stimulation for children and remain pleasurable stimulating activities throughout life. In addition, what may appear to the untrained eye to be a simple act of stick figure drawing is actually a complex variety of psycholinguistic and metacognitive processes which, with continued practice and development, will result in the development of the skills of writing and reading in the child.

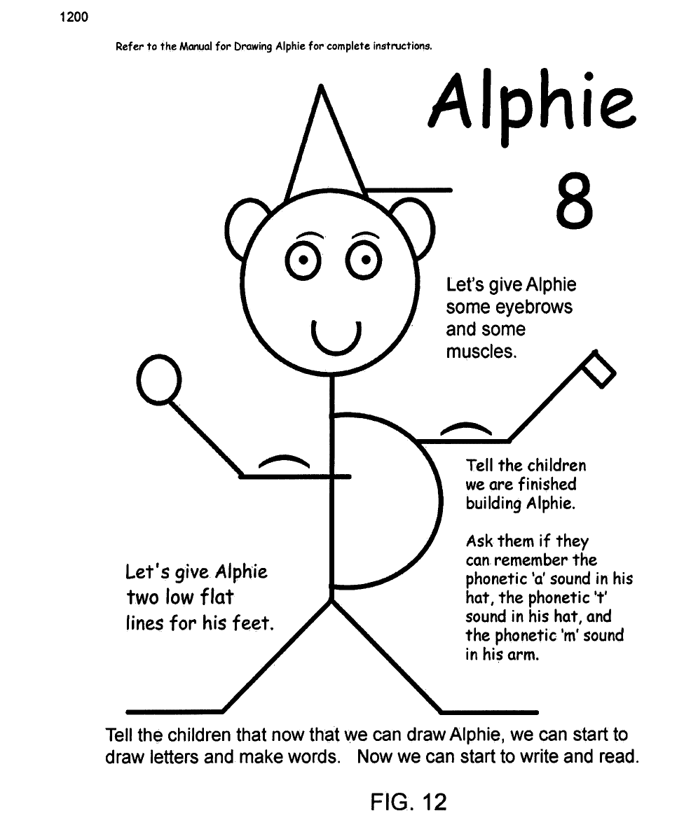

FIG. 5 through and including FIG. 12 were previously referenced in the system chart 100 under the heading “Teacher's Quick Guide for Sketching Alphie, Instructional Entity 1” 112. It is anticipated that many instructors of the system 100 will not be trained professional teachers, and consequently a simplified guide 112 has been provided which is specifically dedicated to the method of drawing the ALPHIE grapholinear (stick) figure that includes script references.

There is a burgeoning consensus concerning the critical importance of phonemic awareness relative to beginning reading success. Although there has been much discussion about how best to define phonemic awareness, what is clear is that phonemic awareness concerns the structure of words rather than their meaning. To grasp what is called the alphabetic principle, that the written word is composed of graphemes that correspond to phonemes, beginning readers must first have some understanding that words are composed of multiple sounds rather than their conceiving of each word as a single sound stream. The preferred method for drawing each picture in the guide 112 ranging from FIG. 5 through FIG. 12 is explained in direct, concrete terms and includes exemplary script which contains particular words that an instructor may use to encourage or prompt the student as well as indicating where and how to phonetically stress syllables, thereby introducing the concept of phonemic awareness into the learning process from the very first lesson of the first level.

Instruction commences when the instructor verbally introduces Alphie by displaying a completed drawing of the Alphie Instructional Entity 110, and then proceeds to model the stroke or strokes needed to conduct the instructional session with the students. The instructor will then proceed to model an additional stroke or strokes to complete the instructional session with the students. Next, the instructor will encourage the students to attempt to make their own version of the Alphie Instructional Entity, or part thereof, that was just modeled, on paper or other suitable surface, with a drawing implement such as a pencil, crayon, marker, or other appropriate device.

As the students first attempt to draw their own versions of Alphie 110, and gradually improve with practice, they will simultaneously be learning to make the orthographic patterns referred to in the system as graphemic segmental strokes 200 depicted in FIG. 2 which, when learned, will constitute a fundamental enabling skill with which the students will be taught to write all of the letters, numerals and punctuation marks required for writing words and sentences. (When these segmental strokes are combined into graphemes and their units of construction are in reliable correspondence to phonological (sound) units, as they will be as instruction progresses, then appropriate sublexical representations will also created and will be connected to a sublexical phonology, further potentiating the nascent writing and reading skills of the child ).

Many pre-school students can be taught to draw a complete version of Alphie 110 in a single session. However, there is no urgency to complete any lesson, and from the very first lesson, it is clearly preferable to follow the principle that building a knowledge base slowly and solidly is preferable to attempting to build a knowledge base that is fragile as a result of insufficient investment of time in the base construction process. (Consolidation is the storage process by which memories become more stable over time. Having a slow consolidation allows for the emotional reaction to a stimulus, which follows its presentation, to influence the memory strength. In this way, important events are less likely to be forgotten.) At this early point in the instruction process occurs the first opportunity for the instructor to make decisions regarding the rate of attempted progress selected for the class, in general, but, more importantly, for each particular student on an individuated basis. Some students will be ready to move on to the next scheduled task with only a one day lag between the first and second lessons; others will need another day or two to practice before producing drawings of sufficient quality to demonstrate a readiness to proceed to the next lesson; still some others may not be ready until even more practice days have transpired.

Each of the steps required to draw the Alphie Instructional Entity 110 is clearly defined and explained in the manual 116 for sketching instructional entities and in the Teachers Quick Guide 112 for sketching the Alphie Instructional Entity as graphically depicted in FIG. 5 through FIG. 12 inclusive.

FIG. 5 depicts the first step of eight exemplary instructional steps in drawing the grapholinear (stick) figure named Alphie.

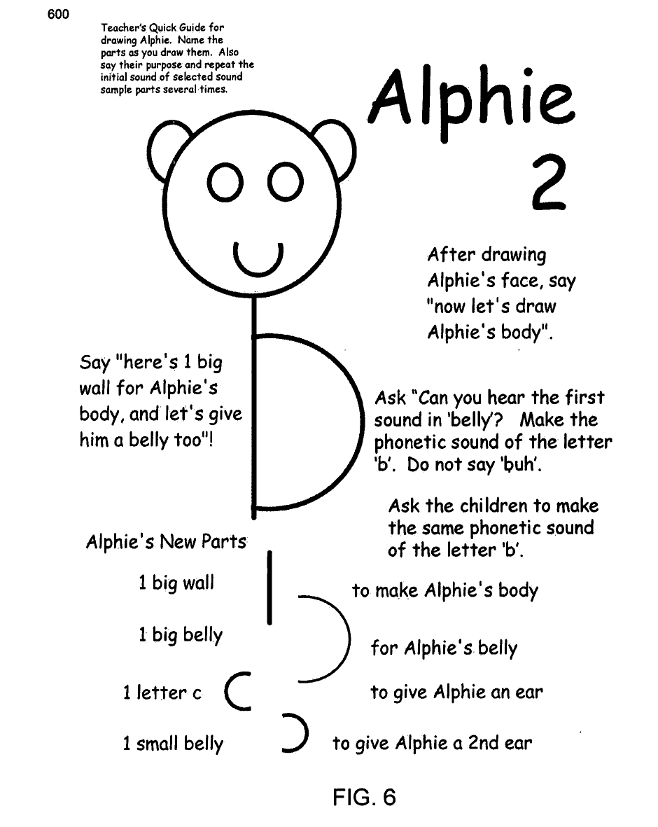

FIG. 6 depicts the second step of eight exemplary instructional steps in drawing the grapholinear (stick) figure named Alphie.

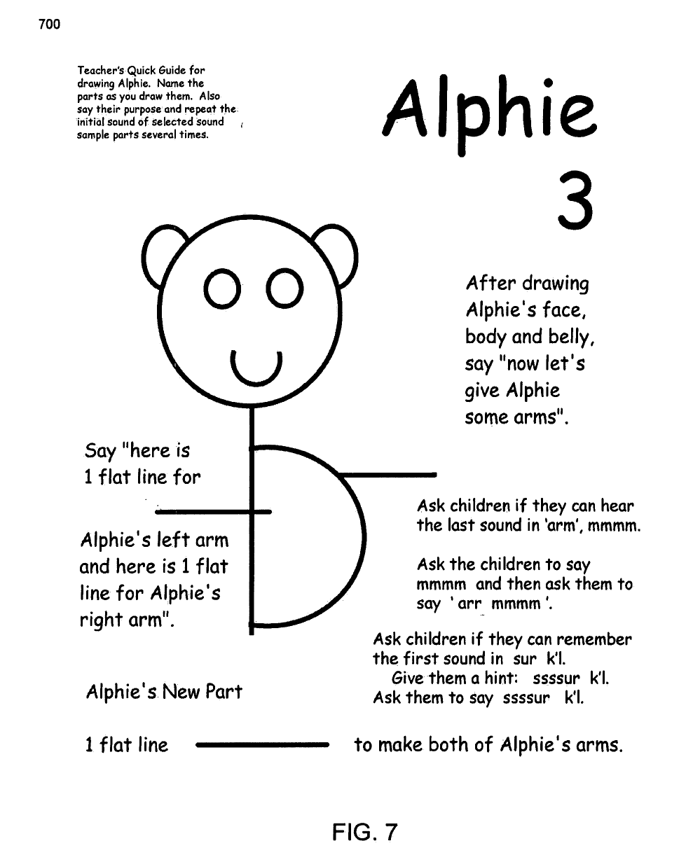

FIG. 7 depicts the third step of eight exemplary instructional steps in drawing the grapholinear (stick) figure named Alphie.

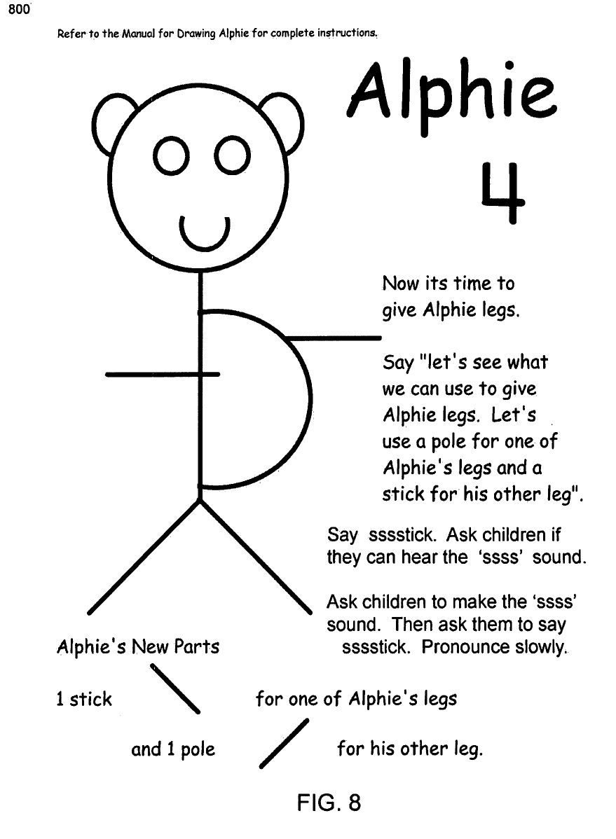

FIG. 8 depicts the fourth step of eight exemplary instructional steps in drawing the grapholinear (stick) figure named Alphie.

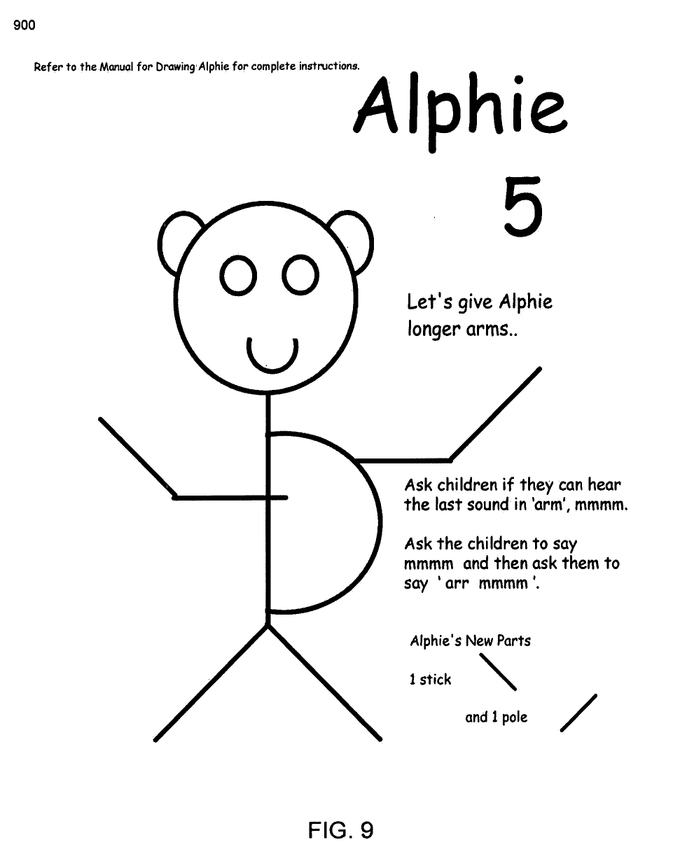

FIG. 9 depicts the fifth step of eight exemplary instructional steps in drawing the grapholinear (stick) figure named Alphie.

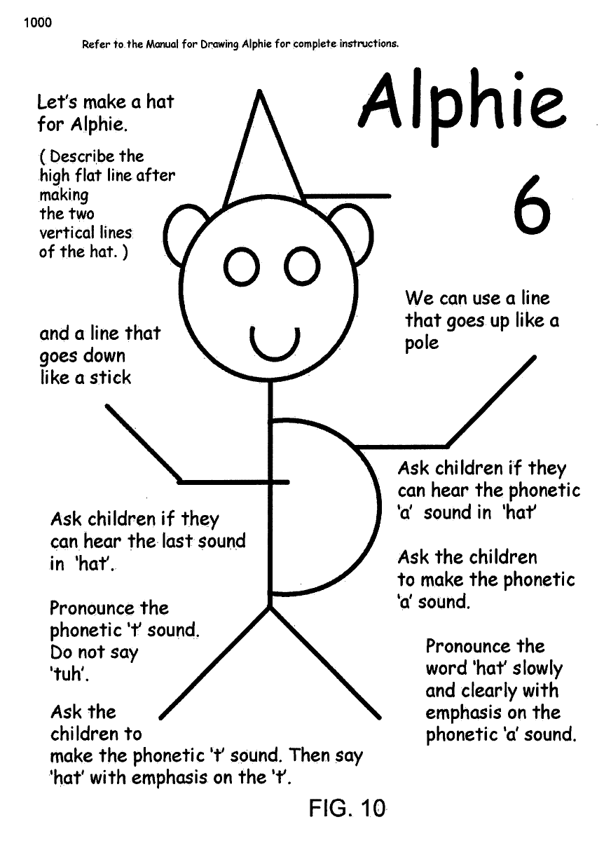

FIG. 10 depicts the sixth step of eight exemplary instructional steps in drawing the grapholinear (stick) figure named Alphie.

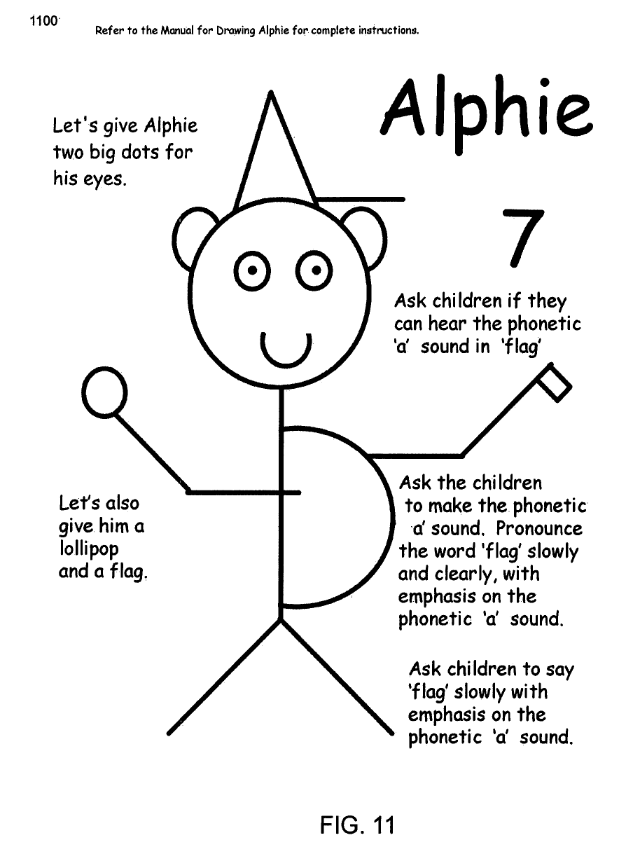

FIG. 11 depicts the seventh step of eight exemplary instructional steps in drawing the grapholinear (stick) figure named Alphie.

FIG. 12 depicts the eighth steps of eight exemplary instructional steps in drawing the grapholinear (stick) figure named Alphie.

One challenge inherent in the design and construction of certain aspects of the present invention is the question of how to produce lesson materials that both express the desired lesson information and generate the desired emotional attitudes toward that information. Without an attitude of interest in the subject, the student is unlikely to learn or acquire much rememberable information about the subject matter.

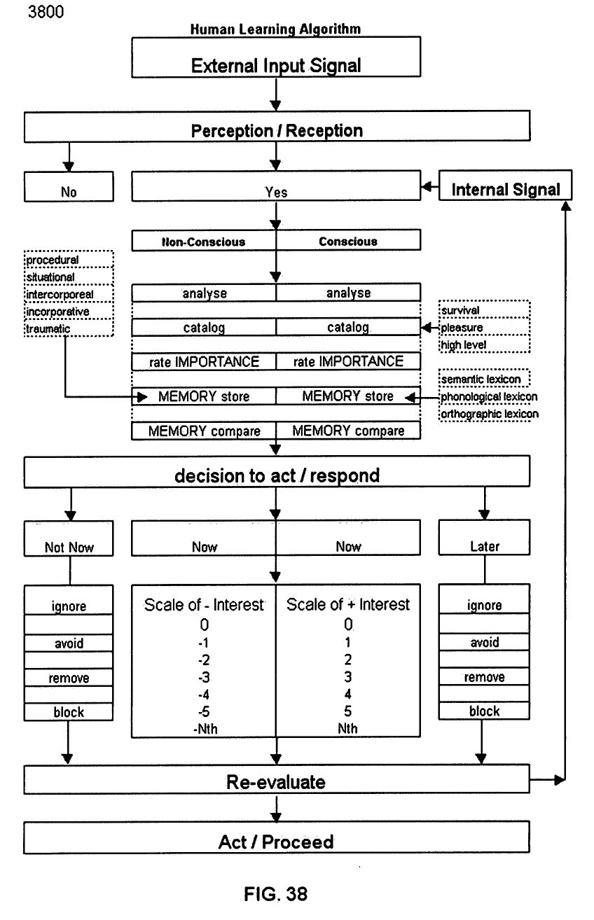

Traditional approaches to the study of cognition have generally excluded emotion. However, with the recent emergence of cognitive neuroscience has come an understanding of the interaction of emotion and human cognition in general and, more specifically, the relationships of: emotional learning and cognition; emotion and memory; and emotion's influence on attention and perception. It has become increasingly apparent that the neural circuitry of emotion and cognition interact from early perception all the way through decision making and reasoning. Consequently, it may be stated that the neural circuitry of emotion plays an integral role in the complex decision making process of a student regarding whether or not to participate at any given moment in any learning process 3800 such as learning to write or read. This learning process 3800 is graphically described in FIG. 38.

Recent research has suggested that a primary function of the human amygdala is the modulation of neural systems underlying cognition and social behaviors in response to emotional cues. Because of its broad connectivity, the amygdala is considered ideally situated to influence cognitive functions in reaction to emotional stimuli such as a friendly face 400, a home 1400, pets, friends, fictional characters 1300, and so on. Although understanding how a stimulus acquires emotional properties is a field of continuing and expanding research, what is established by current research using functional magnetic resonance imaging reporting increased blood oxygenation in the amygdala is that a stimulus, animate or inanimate, can and does acquire emotional properties, and those properties can be aversive, neutral or appetitive. In turn, these three properties will have a significant effect on what is learned, or learnable, by the student.

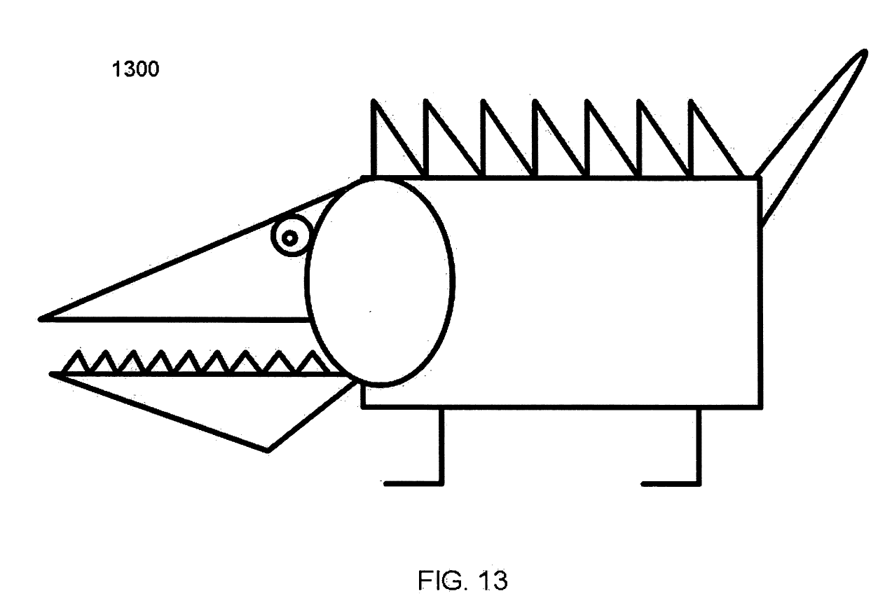

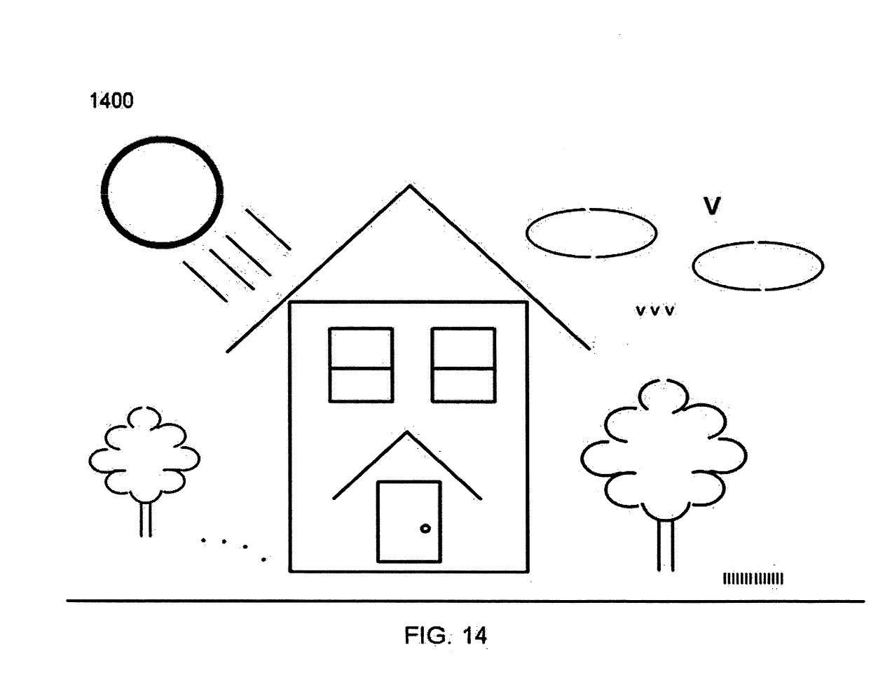

A classic study in 1944 showed subjects a film of different geometric shapes moving around a box. Although these were simple shapes, the nature of the movements of the shapes resulted in the subjects of the study describing the shapes as characters with motives interacting in a complex social situation. Recent studies using a range of neuroscience techniques also report that events that result in an emotional response are less likely to be forgotten and that learning through direct personal experience is a powerful means of emotional learning. Ascribing motives to geometric characters is a means of allowing the subjects to personally participate in the experiences of the geometric figures. The system 100, in its methods and materials, carefully emphasizes both the introduction and maintenance of stimulative environments and situations which will be perceived as appetitive by the student. The recommended story scripts corresponding to FIG. 13 and FIG. 14 as presented in the referenced manual 116 have been carefully constructed to be interesting and appetitive to young children. When the child draws the figures himself, the natural relevance of the subject matter is established and/or enhanced, and the degree of interest in the subject matter by the child is likewise established, strengthened and enhanced.

FIG. 13 and FIG. 14 present two instructional entities each of which is comprised entirely of graphemic segmental strokes 200, and both constitute exemplary representations of instructional entities that are of special interest to young children and are emotionally salient to young children. In addition, as each child creates his own version of each instructional entity sketch, the knowledge gained is generalizable along a continuum of growing skills where each sketch produced enhances the fundamental enabling skill of drawing orthographic forms by which the young artist student acquires the knowledge necessary to participate in the arts of writing, reading and comprehending. The drawing process also contributes to development of multiple metacognitive skills which enable the child to learn how to learn.

FIG. 13 presents a fictional dinosaur character that is composed of the graphemic segmental strokes 200 presented in FIG. 2, and therefore, despite its apparent complexity, this figure may actually be drawn by children aged 4 years and even younger. These sketches are of paramount importance in the system 100 and it is well worth repeating that the knowledge gained by a young child during the drawing process is generalizable along a continuum of growing skills where each sketch produced potentiates the fundamental enabling skill of drawing orthographic forms by which the young student acquires the knowledge and skills necessary to participate in the arts of writing, reading and comprehending. And, as noted, the drawing process also contributes to development of multiple metacognitive skills which enable the child to learn how to learn.

FIG. 13, in an exemplary fashion, also presents many opportunities for interaction of the instructor with the student ranging from merely modeling the drawing technique to a highly creative story telling engagement. For example, as encouraged in the referenced manual for sketching instructional entities 116, an instructor might describe the depiction in FIG. 13 as a baby blue and brown dinosaur also possessed of additional colors including beige and black with a little red in his eyes and white in his teeth. The instructor might explain that the name of the baby dinosaur is Big Jaw, but whose friends affectionately call Boxie. The instructor could elaborate by explaining that Boxie Big Jaw's box-like body is mostly hollow and his soft neck is like a turtle's neck that allows Boxie to return his head into his boxy body for sleeping, or to get it out of the rain, or to hide from other dinosaurs. In this story telling manner, the emotional salience of the dinosaur is enhanced, as are the student's interest and focus. As is pointed out in the referenced manual 116, the precise story telling script is not critical, and many embellishments are possible. However, once established by an instructor, the referenced manual 116 points out that children prefer consistency of detail in their stories and, therefore, the referenced manual 116 recommends that instructors generally follow the suggested story telling themes and scripts.

FIG. 14 presents a scene in which a house, trees, the sun, clouds, birds and ants are depicted. The constituent parts of this picture may all be drawn by utilization of the graphemic segmental strokes 200 presented in FIG. 2, and therefore, this apparently complex scene may actually be drawn by children aged 4 years and younger. A simple sketch of a house is actually highly emotionally charged for a young student. Young children's earliest attempts at drawing and story telling very frequently involve pictures they have drawn, or scribbled, which they themselves explain, upon request, as pictures of their own homes and attendant activities. These drawings and scribblings may therefore validly be described as being imbued with an interest generating and sustaining natural relevance for their child authors.

It is the contention of the inventor and a premise of the use and application of the present invention 100 that anyone of any age who is possessed of sufficient manual prehensile capability and dexterity who can make the orthographic marks 200 referred to herein as graphemic segmental strokes 200 that comprise the grapholinear figures depicted in FIG. 13 and FIG. 14 can also write or draw any of the twenty six majuscule and miniscule letters, ten numbers and the 14 various punctuation marks of the English language. However, this ability alone does not constitute a guarantee that a student will actually develop writing and reading skills for the reason that the drawing skill in context may result in any of three stimulative consequences for the student, these being: aversive, neutral and appetitive. It is the development of metacognitive skills involved in learning how to learn, that is, learning how to learn what is deemed most desirable to learn, that will guide and direct the student to acquisition of the desired skills of writing and reading.

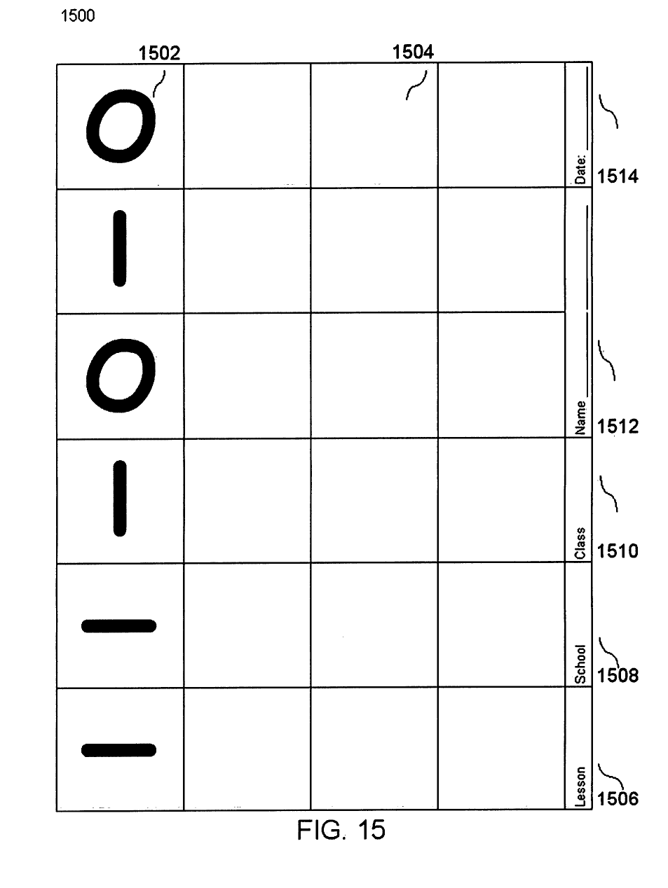

FIG. 15 presents, as style one. an exemplary elicitation frame form 1500 initially intended for use in teaching the graphemic segmental strokes 200 previously referenced 104 in FIG. 2. Graphemic segmental strokes 200 constitute the atomic particles of grapheme construction and as such are the basic and essential components of printing and writing. In subsequent embodiments of the system 100, elicitation frame forms are modified in such manner as to provide an instructor with an appropriate means and subject matter for engaging in an interactive teaching session with a student relative to a lesson and level of the system 100 which has been determined by the instructor to be consistent with a predetermined schedule for, and acquired knowledge base of, the individual student. Individuated lessons may include any number of subject matter items with which an instructor may engage in interactive sessions with students.

In a typical exemplary embodiment, lessons with students are designed to be given under live instructor supervision. However, various implementations of the system 100 are possible. In one embodiment, the system 100 may comprise a computing system which may be implemented in the form of a computer or network system of computers including the internet. In another embodiment, lessons may be embodied in electronic, optical, audio tapes, video tapes, computer discs, digital discs, or other forms or mediums which may include depictions, graphical recreations, and/or representations of the lessons and lesson subject matter discussed herein. In another embodiment, the system 100 may be comprised of any suitable implementation which is known in the art or may hereafter be devised. In all embodiments, appropriately structured elicitation frames 1500 are employed, the particular design being subject matter and situation dependent.

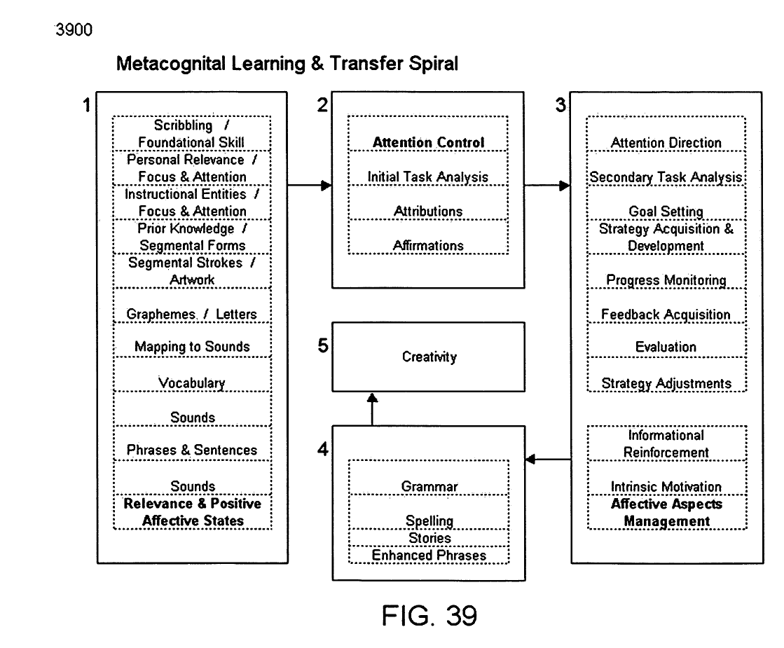

The consistent use of various styles of elicitation frames both allows for the desired presentation and modeling of lesson materials and aids in the facilitation of direct personal experiences by the student, heightening emotional salience of the lesson materials in particular and enhancing efficacy of the system 100 in general. In addition, the visible-content-framework format allows greater observability of individual components, and experimentation with and manipulation of individual components. These features of observability, experimentation and manipulation lead to metacognitive skills being developed, strengthened and enhanced. In turn, enhanced metacognitive skills circuitously lead to learning of the presented subject matter. Iterations of the processes lead to a deepening of the knowledge gained and may validly be described as being both circuitous and spiraling in nature. This circuitous spiraling process 3900 is graphically depicted in FIG. 39.

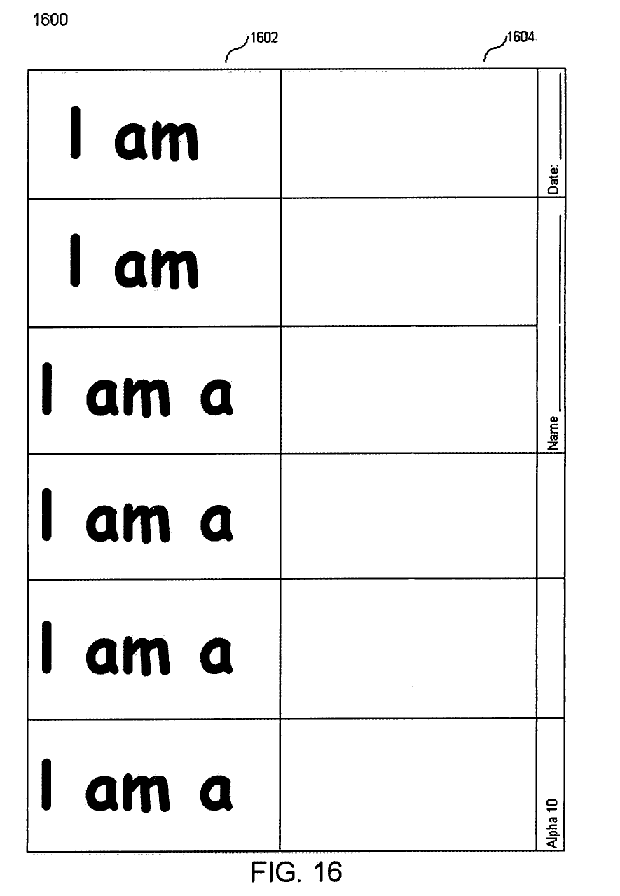

FIG. 16 presents, as style two, an exemplary elicitation frame form.

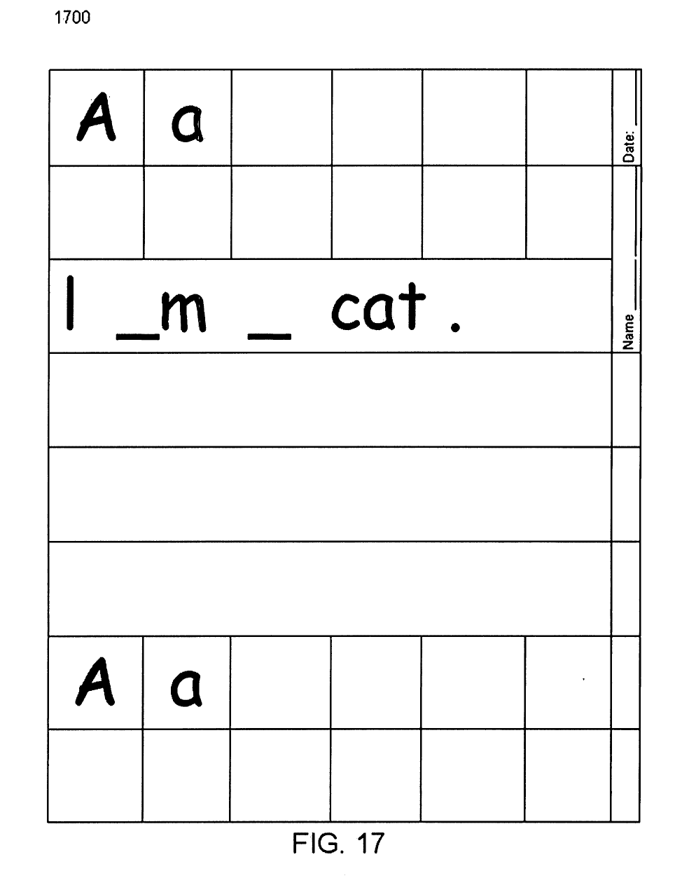

FIG. 17 presents, as style three, an exemplary elicitational frame form.

These three (FIG. 15, FIG. 16, and FIG. 17) exemplary elicitational frame forms demonstrate the variability within the system 100 that enables the full depth and breadth of the English language to be taught by instructors utilizing the system 100. They also demonstrate a necessary mutability within the system required to keep the subject matter of interest to the students.

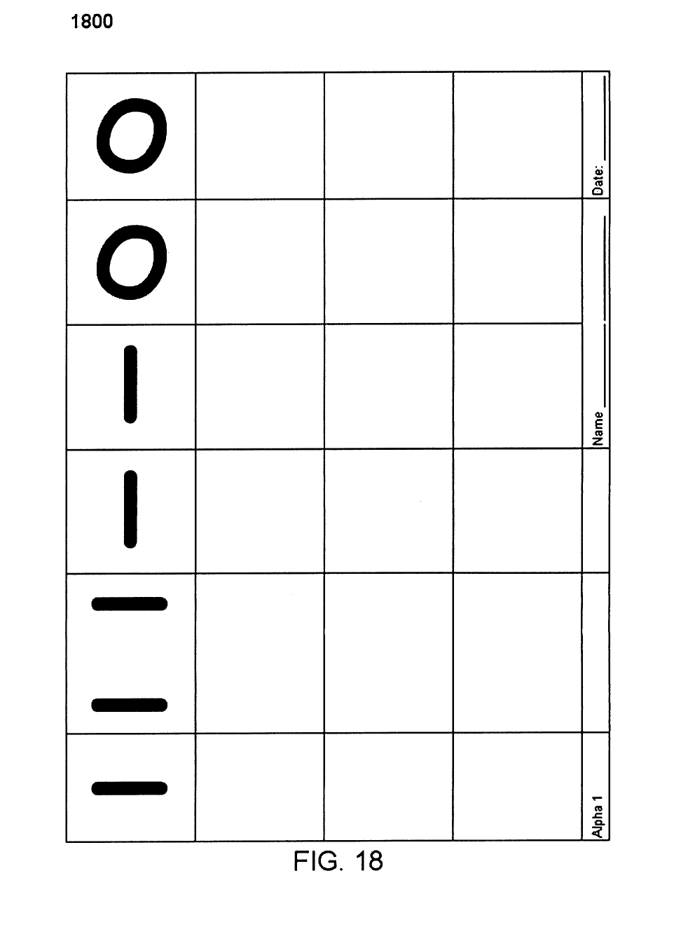

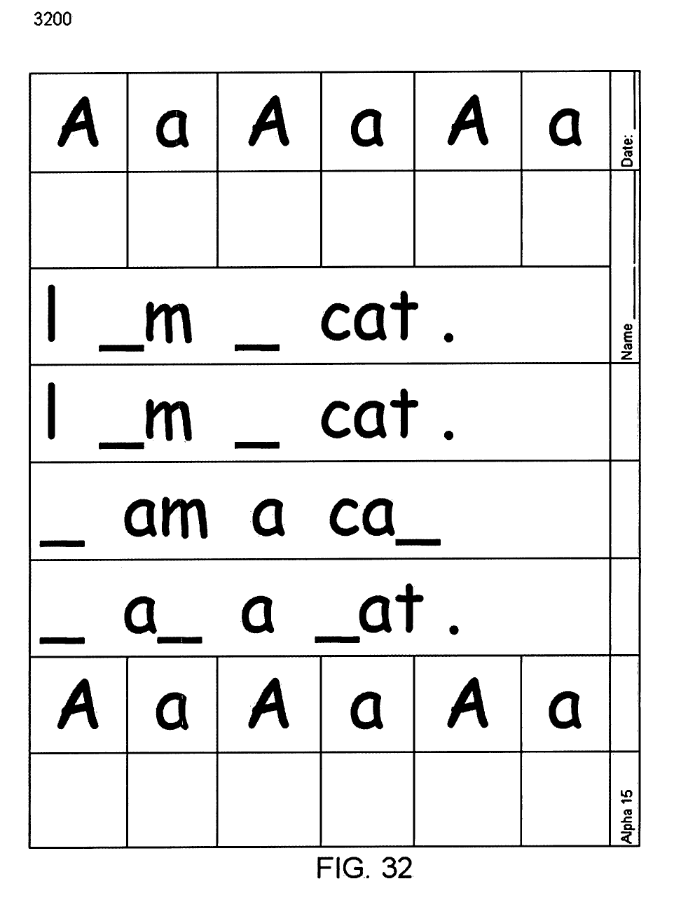

FIG. 18 presents an exemplary first lesson of an exemplary first level on an exemplary elicitation frame form 1500. This lesson is commenced with the instructor demonstrating the purpose and use of the form for the children, that is, the instructor will verbally explain while drawing that the form displayed in the first block space on the page is to be copied into the empty block space adjoining the example, and this process is to be repeated for all forms the child can see on the page. This exemplary first lesson emphasizes the circle, the 90 degree vertical ‘wall’ line and the relative positions of the 180 degree flat line which will eventually be utilized in three different positions as exemplified in the upper case letter “E”. Also verbally introduced by the teacher in this first lesson is the long vowel sound of the upper case letter “I”. Although the circle also constitutes both the upper case “O” and the lower case “o”, it is not discussed as a letter at this time. Note that FIG. 18 through and including FIG. 32 comprise the graphic component of an exemplary complete manual 124 of lessons and elicitation frame forms previously referenced as part of the system 100.

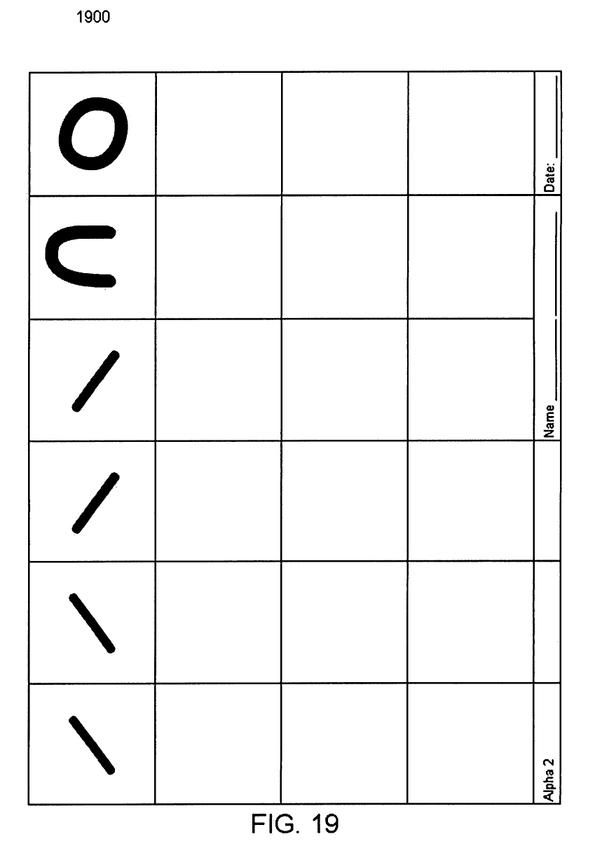

FIG. 19 presents an exemplary second lesson of an exemplary first level on an exemplary elicitational frame form. This lesson emphasizes the two forms of angled strokes, the semi-circular form that will become the letter “C” and part of the lower case letter “a”, and reviews the circle form that will later be called the letter “O”. Very little instruction is required from the instructor and most pre-school three and four year old children grasp the concept of imitatively drawing exampled strokes into provided blank spaces on the elicitation frame form 1800 after only one or two trials or demonstrations. Subsequent instruction is usually minimal or altogether unnecessary as the student recognizes the elicitation frame form and is able to proceed intuitively.

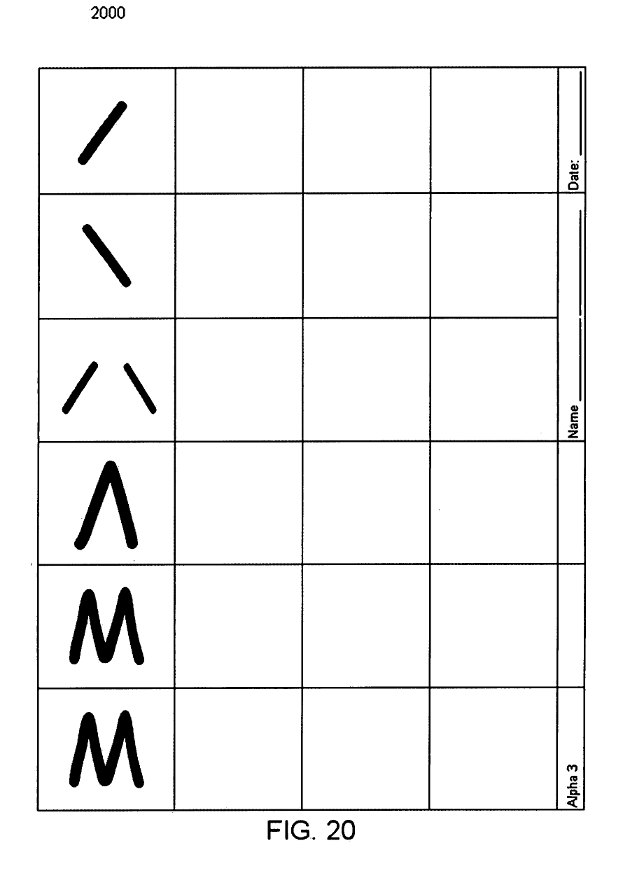

FIG. 20 presents an exemplary third lesson of an exemplary first level on an exemplary elicitational frame form. This lesson continues study and practice of the two angled strokes and shows how these angled strokes are merged into an inverted V which then grows into the capital letter “M”. This letter is introduced here because it is a logical progression from the study of the angled strokes and because it will allow for an easily learned transition into the lower case letter “m” in the next lesson. Also re-introduced in this lesson is the sound of the letter “M” which was first mentioned during the lesson involving FIG. 7. The relevance and importance of the lower case letter “m” will become clear in the fifth and sixth lessons.

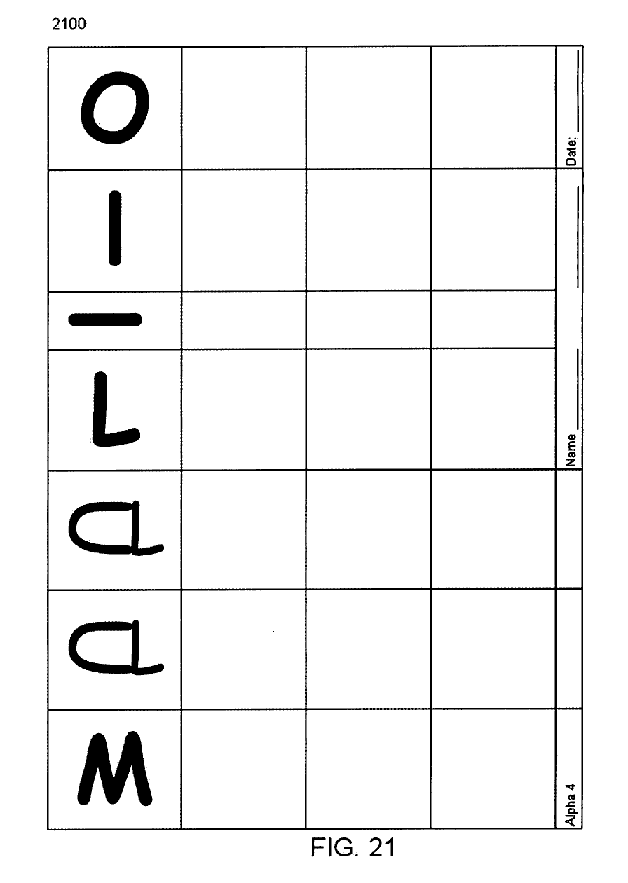

FIG. 21 presents an exemplary fourth lesson of an exemplary first level on an exemplary elicitational frame form. This lesson reviews previously learned forms and introduces two combinations of previously learned forms. First, the vertical ‘wall’ line is combined with a low flat line to produce what will later be later be taught as the upper case letter “L”. However, here, this “L” form is not taught as the letter “L” but is combined with another previously learned form, the semi-circle “C” form, to produce an approximated version of the lower case letter “a”. The phonetic sound of the lower case letter “a” as heard in the words mat, bat, cat, etc., is verbally introduced here by the instructor. The long sound of the capital “I” and the phonetic sound of the letter “M” are also verbally reviewed with students in this lesson.

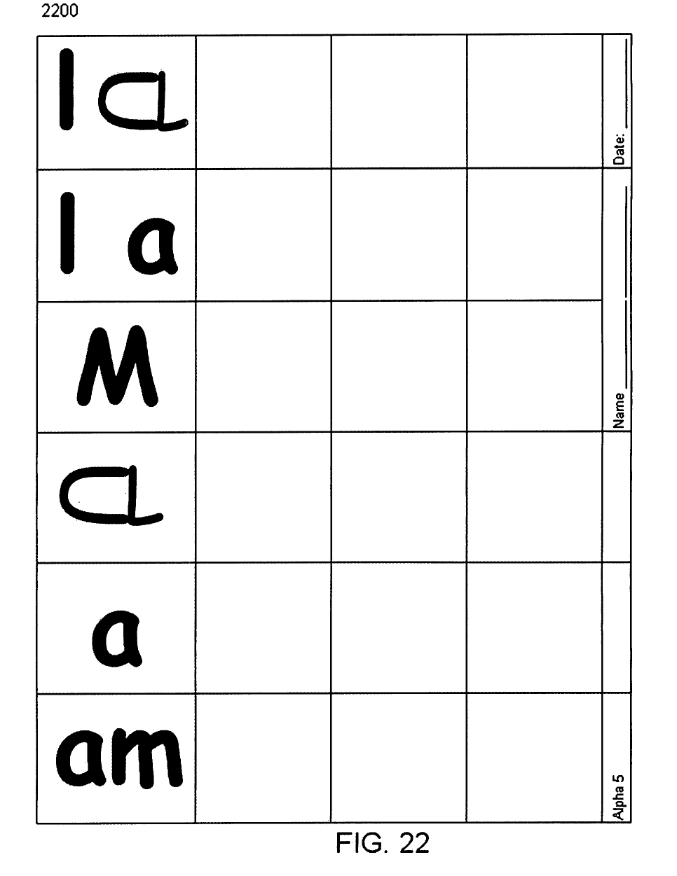

FIG. 22 presents an exemplary fifth lesson of an exemplary first level on an exemplary elicitational frame form. In this letter, the lower case letter “a” is practiced, refined placed in close proximity to the previously practiced vertical ‘wall’ stroke which the child has already learned to equate with the long “I” vowel sound. Although the lower case letter “m” can be seen on the elicitation form, the instructor has been instructed not to discuss the letter at this time. There is no need to discuss the differences between the upper and lower case “M” letters at this time, and the kinesthetic requirements for drawing the lower case letter “m” have already been learned by the student while practicing the upper case letter “M”. Therefore, introducing the lower case letter “m” without verbal instruction provides an opportunity for the student to transfer the knowledge gained previously to the production of this new letter. If successfully produced without verbal instruction, the lower case “m” demonstrates that the student is independently learning how to learn. Of course, the child is unaware that the nascent skill of learning how to learn is being taught and tested. The instructor, on the other hand, is aware of the significance of the placement of the lower case “m” on this lesson and can take advantage of the opportunity to ask whether the lower case “m” looks similar to any other letter, thereby coaxing the student to examine and compare.

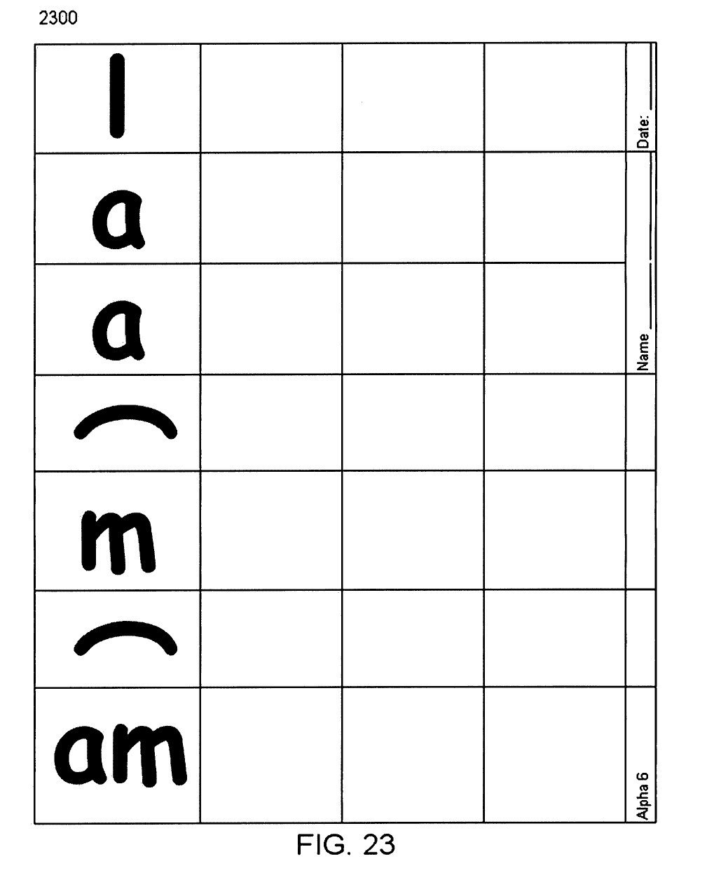

FIG. 23 presents an exemplary sixth lesson of an exemplary first level on an exemplary elicitational frame form. This lesson practices previously learned forms and sounds and introduces the quarter circle ‘eye brow’ line that will be utilized in drawing several letters (f, h, m, n, r). As in the previous lesson, the lower case letter “m” is present without verbal instruction from the instructor. However, if the instructor observes that the student struggles or is unable to construct the letter “m” on his own, the teacher will advise the student that the letter “m” is built from straight lines that are connected by the newly practiced eye brow line which the child may remember from the eighth drawing lesson of the Alphie figure. (At any time when an instructor observes that a child is struggling with an element of a lesson, the instructor may take a number of actions to assist the child ranging from asking questions about the new lesson, to coaxing observations from the child about the new lesson, to modeling the new lesson for the child, or returning to a previous level of instruction where the child was successful.)

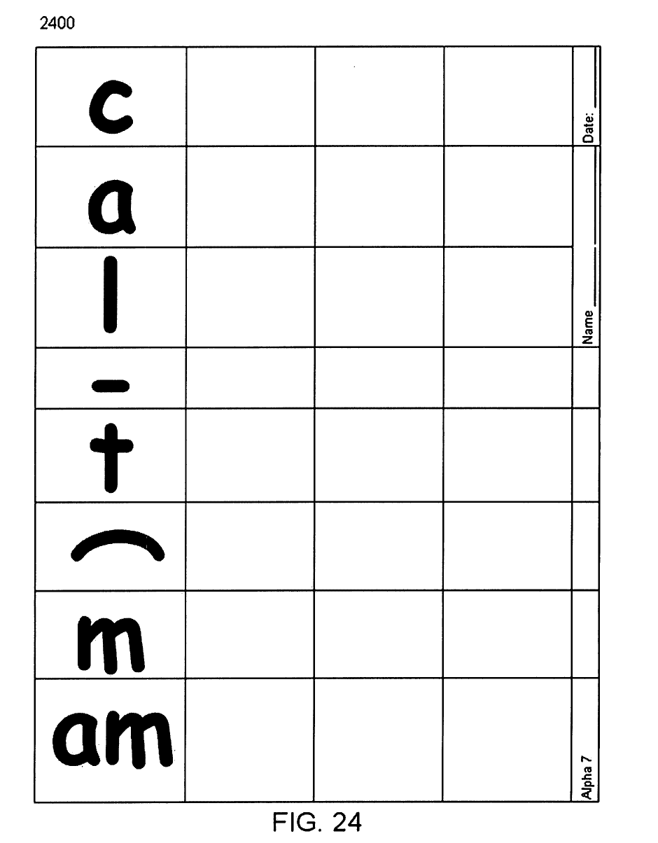

FIG. 24 presents an exemplary seventh lesson of an exemplary first level on an exemplary elicitational frame form. Two lower case letters “c” and “t” are introduced in this lesson, as well as the hard “c” (k) sound and the phonetic “t” sound.

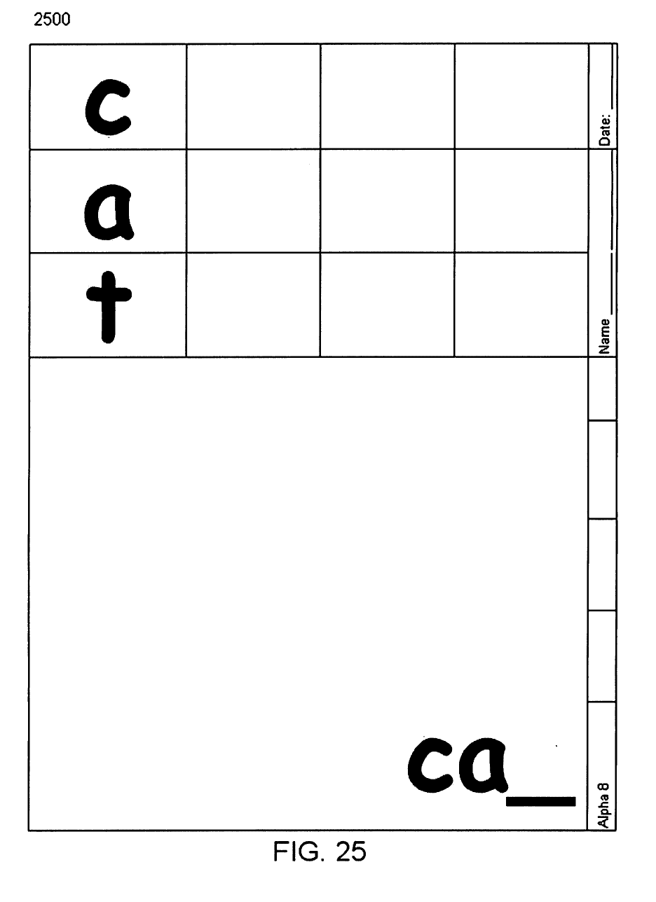

FIG. 25 presents an exemplary eighth lesson of an exemplary first level on an exemplary elicitational frame form. This lesson reviews the sounds and shapes of 3 lower case letters (c, a and t ). Previously, the child has learned to draw several straight and curved lines called graphemic strokes. These specialized strokes have been used to teach the child to construct several letters (l, a, c, m, t), and to construct two words (I, am) This lesson now broadens and deepens the involvement of the child with the learning process by inviting him to draw a new instructional entity, a cat. The same graphemic strokes previously learned by the child that were used to draw the Alphie instructional entity will now be used to draw the cat, and so the child is drawing upon a base of previous acquired knowledge and skill. The instructor, of course, first demonstrates the method to the children. By drawing the cat, the child is demonstrating an ability to transfer previously acquired knowledge to a novel situation. In addition, the child is increasing his emotional involvement with the subject matter and with the learning process, as well. The child is also attenuating his own satisfaction with his kinesthetic skills and building a foundation for deserved self esteem. The child also becomes aware that the same stroke forms can have multiple applications and multiple associations. The child is also developing a relationship with the learning process that is appetitive and increases the probability of learning how to learn.

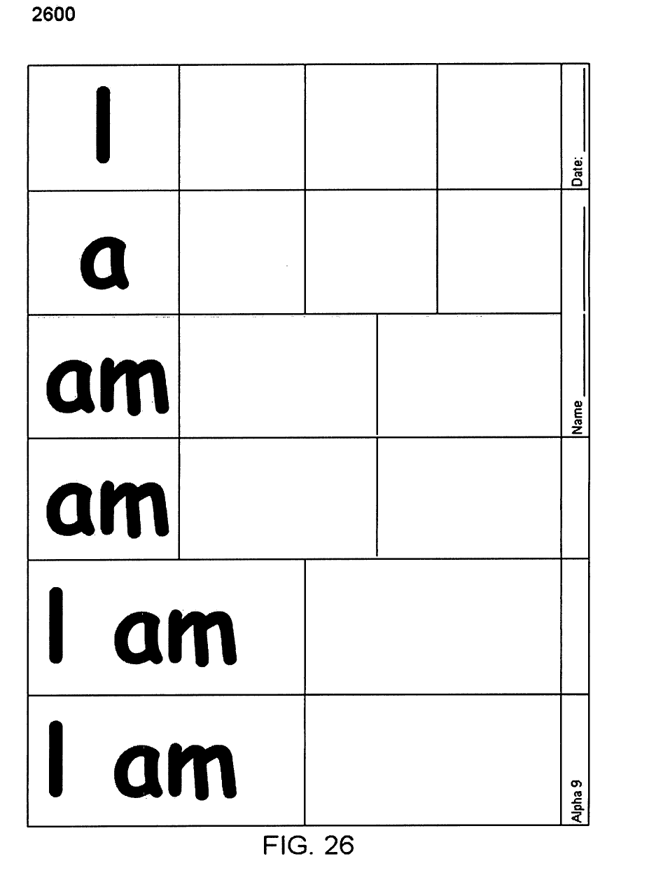

FIG. 26 presents an exemplary ninth lesson of an exemplary first level on an exemplary elicitational frame form. This lesson is the first to introduce the construction of a complete sentence, “I am”. The child can write this sentence, but what is of greater importance, the child can recognize the words of the sentence and associate them with their appropriate sounds. Although this short sentence is deeply metaphysical in its total implications for an adult, it is nonetheless a sentence the simple meaning of which can be comprehended by a child: “I am alive”. Therefore, this lesson presents a child with an opportunity to write, read and comprehend what he has written. Moreover, this ability to write and read is recognized by the child at full face value and generates in the mind of the child a confidence building affirmation stating that “I can do this”.

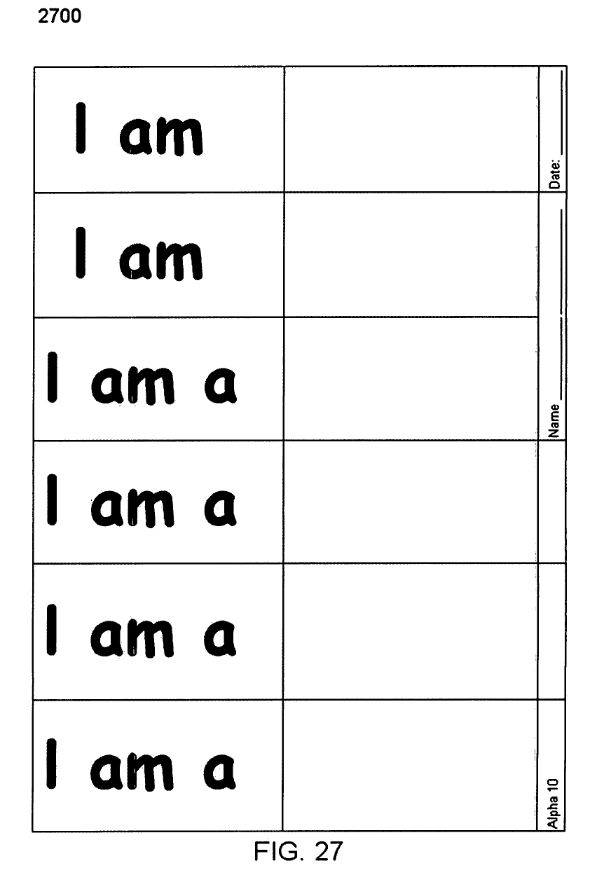

FIG. 27 presents an exemplary tenth lesson of an exemplary first level on an exemplary elicitational frame form. This lesson provides an opportunity to solidify the sentence building skill of the child and to begin to expand it into even more personally relevant territory for the child. In addition, a new sound is introduced for the letter “a”, that being the sound of the letter “a” as it is pronounced in the first and last sounds of the word America (“uh” sound). This new sound will be utilized in the next lesson.

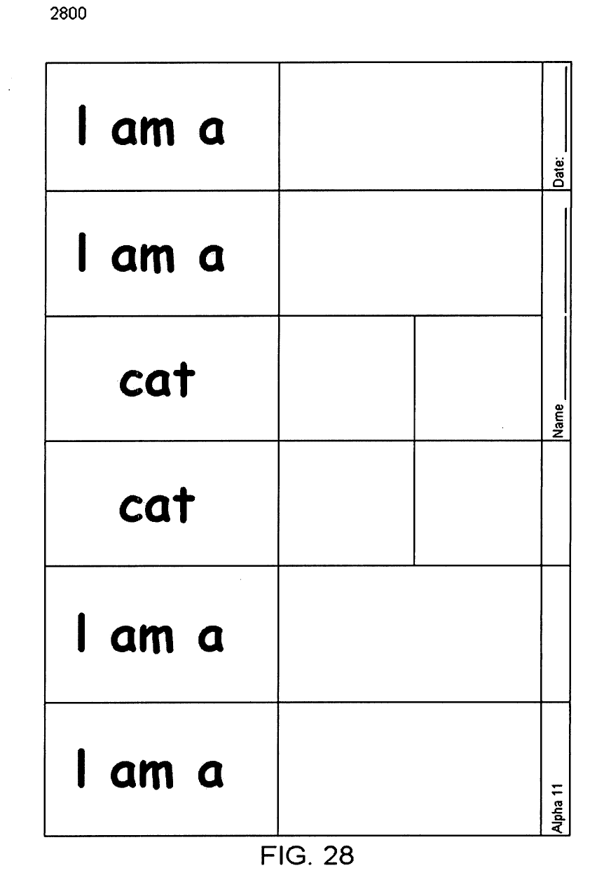

FIG. 28 presents an exemplary eleventh lesson of an exemplary first level on an exemplary elicitational frame form. This lesson re-introduces the word “cat” previously seen in lesson eight. This lesson also lays the foundation for the next lesson that will yield another complete sentence.

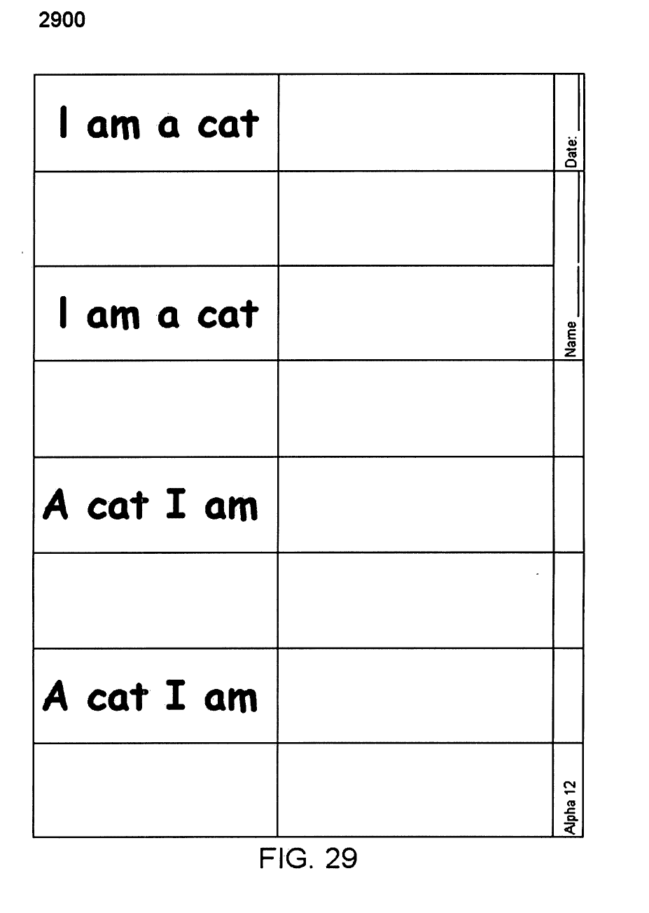

FIG. 29 presents an exemplary twelfth lesson of an exemplary first level on an exemplary elicitational frame form. This lesson provides the second and third sentences of Level 1 and brings a touch of humor into the learning process that allows any tension that may have been inadvertently building within the learning process to be gently dissipated. The humor constitutes an intrinsic reward for having maintained the focus necessary to reach this point along the instructional continuum. In addition, the upper case version of the letter “A” is introduced. The concept of capitalization of first words in sentences is mentioned here by the instructor. An additional aspect of learning how to learn is also introduced in this lesson: cognitive restructuring, a linguistic as well as cognitive device that enables the student to restate what he has previously learned.

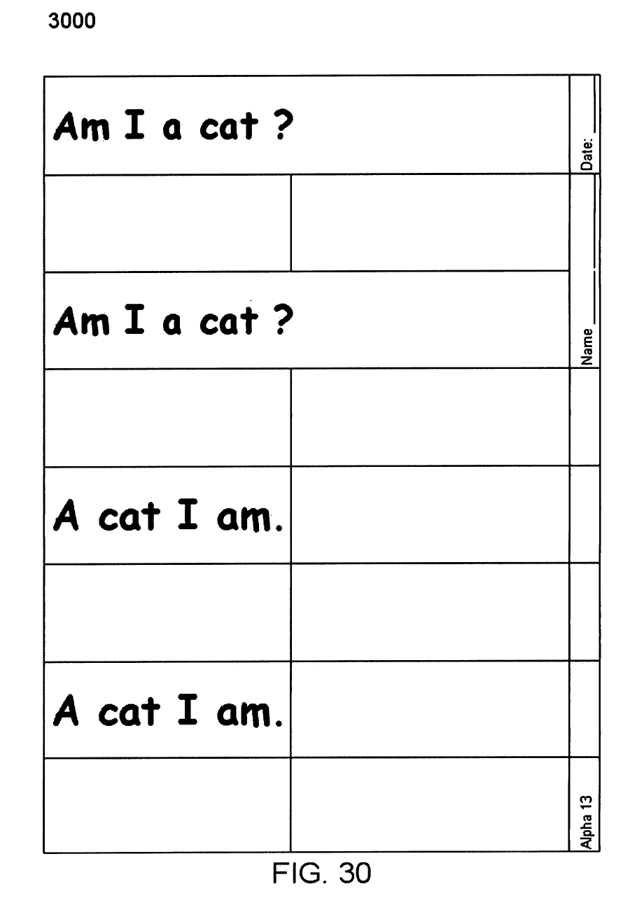

FIG. 30 presents an exemplary thirteenth lesson of an exemplary first level on an exemplary elicitational frame form. This lesson provides two more examples of cognitive restructuring and introduces the asking of questions into the learning structure of Level 1. This lesson also lays the foundation for the introduction and incorporation of the external device of flash cards, the utilization of which serves to prove that the student has learned the distinctions between the words he has constructed and is able to employ them in various configurations.

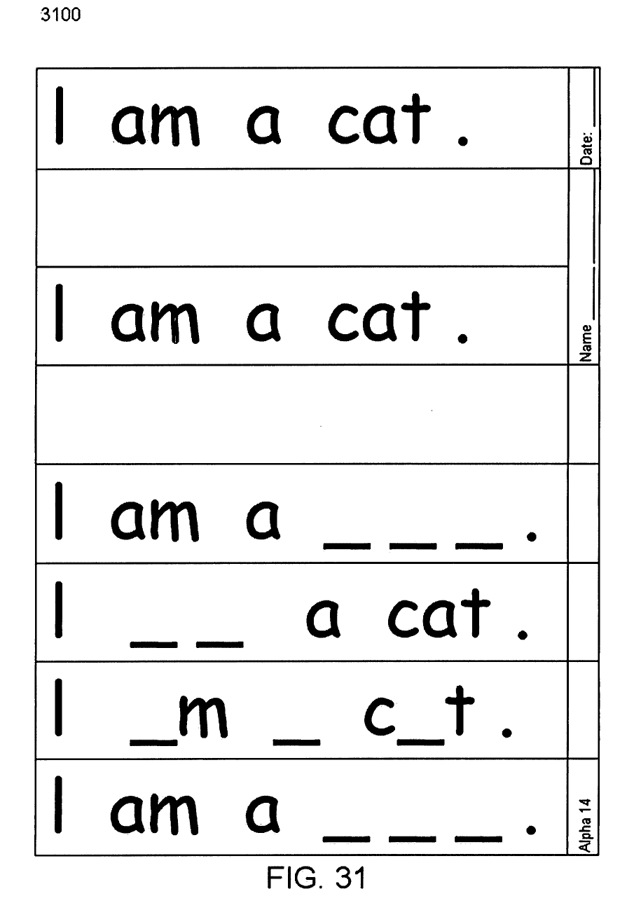

FIG. 31 presents an exemplary fourteenth lesson of an exemplary first level on an exemplary elicitational frame form. This lesson provides practice opportunities for writing, reading, task analysis and problem solving. In effect, the student is being introduced to the concept of testing. Upon completion of this lesson, the student is presented with formal documentation of success that may be in the form of a prize, ribbon or certificate imprinted with the student's name. Formal documentation of success increases intrinsic motivation and aids the student in self management of his affective states.

FIG. 32 presents an exemplary fifteenth lesson of an exemplary first level on an exemplary elicitational frame form. This lesson provides additional practice opportunities for writing, reading, task analysis and problem solving. Upon completion of this lesson, the student is again presented with formal documentation of success in the form of a prize, ribbon or certificate imprinted with the student's name. This second presentation of formal documentation of success reinforces and increases intrinsic motivation and solidifies the student's developing skills in self management of his affective states.

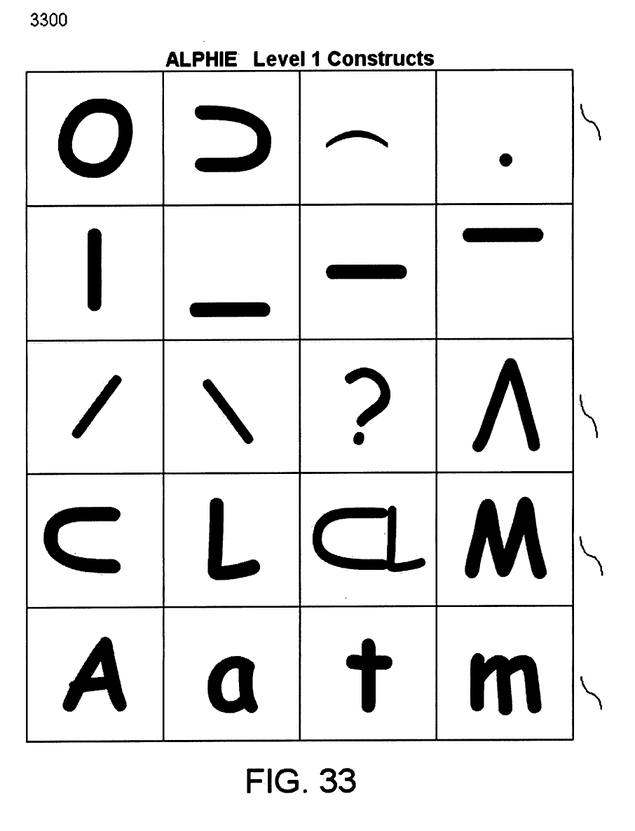

FIG. 33 depicts a chart of all of the graphemic segmental strokes and constructions utilized in the lessons comprising Level One of the system 100 and therefore constitutes both a graphic introduction to and summary review of the Level One orthographic requirements and expectations which together form the foundation for all subsequent levels and lessons.

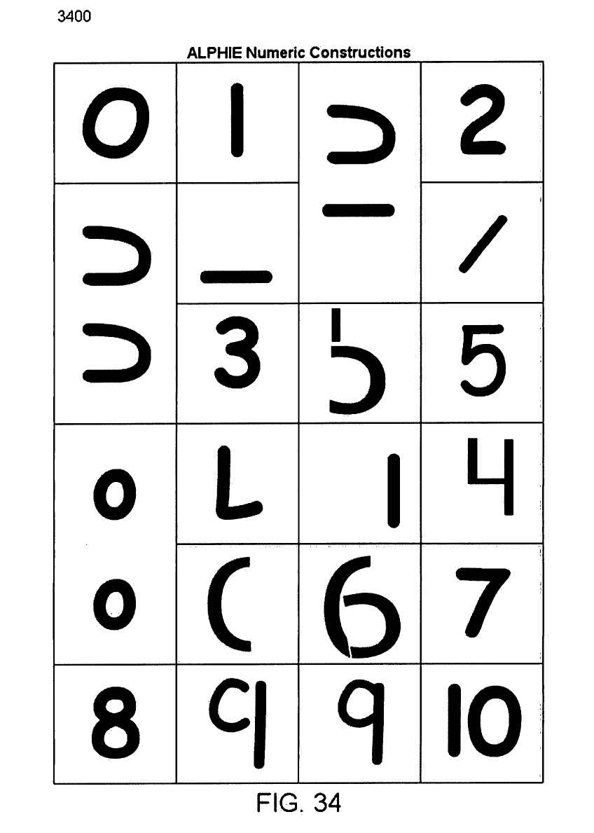

FIG. 34 depicts a chart of graphemic segmental strokes and constructions utilized to draw the ten base numerals from zero through nine. After learning these segmental strokes 200, the student is empowered to write any Arabic number.

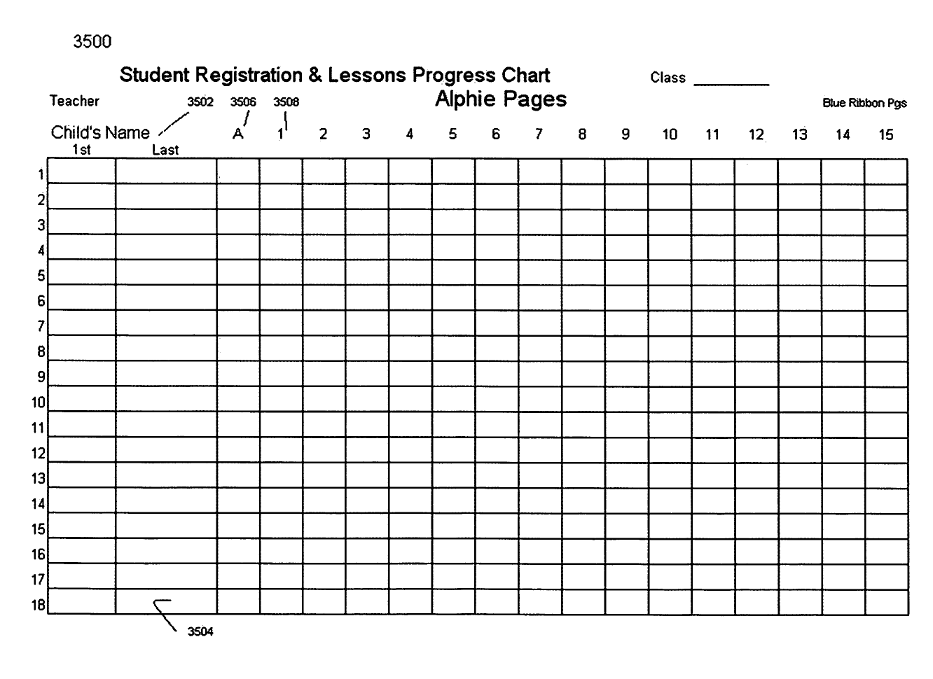

FIG. 35 depicts an exemplary self charting class registration and lesson progress form that serves both to identify the individual students and to specify the level and position of accomplishments of each individual student. The instructor, having first become knowledgeable in the purposes, plans, methods and overall implementation of the system 100 by reading and reviewing the general manual 102, initiates an exemplary course of instruction by entering the names 3502 of participating students in the appropriate spaces 3504 provided on the registration form 136. This exemplary registration and learning progress form 3500 constitutes the chief data collection tool as well as student identifier of the system 100. Ultimately, the degree to which classroom data are collected and used for instructional decision making depends on the instructor and in turn, the degree to which classroom data become part of daily decision making depends on the instructor's ability to: (1) make data a priority for decision making; (2) employ effective data driven decision making; and (3) create time within existing structures and practices for working with data. The first column following the name of the student is headed by the letter “A” (for Alphie) 3506. In the appropriate blank space 3504 corresponding with the name of a particular student, the instructor will enter the date on which the student was first afforded the instruction and opportunity to make an initial effort to draw one or more of the graphemic strokes of which the Alphie Instructional Entity 110 is comprised.

The first column following the column headed by the letter “A” 3506 is headed by the number 1 and refers to the subject matter established as Lesson One. In the appropriate blank space 3504 on column 1 corresponding with the name of a particular student, the instructor will enter the date on which the student is first afforded the instruction and opportunity to make an initial effort to draw one or more graphemic strokes on a specialized form called an elicitation frame form 1800. The instructor will first model the graphemic strokes for the students and then the instructor will encourage the students to imitate drawing the strokes into empty spaces adjacent to the sample strokes provided on the elicitation frame form 1800.

Through diligent use of the registration and learning process form 3500, it is within the capability of all instructors using the system 100 to create and maintain appetitive learning conditions from the very first day of school by avoiding the imposition of unnecessary stress and tension that may result from selection of less than optimal schedules for individual students. The system 100 is so designed as to allow individuated progress at a rate and pace selected by the instructor, or by the student, or preferably both. By simple observation, the instructor can determine the student's readiness to move to the next lesson. However, the manual 102 recommends that instructors frequently ask the question “Who wants to try the next lesson?” By so doing, the student is encouraged to, and does, take a more active participation in decisions and activities that, by virtue of participation, are of particular interest and relevance to the student. In addition, an element of control is transferred from the instructor to the student, thereby increasing options for the student while decreasing frustration and stress points for the student. It may be noteworthy here to mention that the presentation of an option to proceed would be considered a branching point In modern computer based game play where the concepts of user interaction and choice regarding interruption, direction and redirection are considered paramount to maintaining interest and playability.

Adults have learned, for the most part, that it is eminently practical to approach the world with far less flexible patterns of attention than children. Children, on the other hand, have very few preconceived notions or organized interests through which novel situations and novel impressions are filtered. The result is an extreme sensitiveness in youth to novel stimuli. Children are captivated by sensory impressions not because they serve as a means to some remote end, but because they are exciting or interesting per se. The intensity of excitement or level of interest is potentiated by increasing the involvement of the child with the stimuli from mere observation to active participation, thereby enhancing the inherently appetitive nature of learning situations for children. By encouraging progress according to individuated foundational readiness, the system 100 is able to provide instructors with the means to maintain appetitive learning conditions that lead to continued desire for participation in learning opportunities by the student and corresponding growth in learning by the student.

As the lessons progress from one to the next, until completion of each level and a new series of lessons commences, the instructor will enter the date on which the student is first afforded instruction and an opportunity to make an appropriate entry on the specialized elicitation frame form 1800. The instructor will first model the entries for the students and then the instructor will encourage the students to imitate making the appropriate entries into empty spaces adjacent to the sample entries provided on the elicitation frame form 1800.

As the lessons continue, each day will present new opportunities for the instructor to make decisions on an individuated basis regarding the rate of attempted progress for each particular student. As previously observed, some students will be ready to move on to the next scheduled task with only a one day lag between the first and second lessons; others will need another day or two to practice before producing drawings of sufficient quality to demonstrate a readiness to proceed to the next lesson; still some others may not be ready until even more practice days have transpired. Other decisions may also be regularly made concerning, for example, whether the instructor should model for the student the desired pattern on the student's form. Still another decision may be made concerning whether to modify the form to include hints for a student to observe in the form of partial patterns pre-drawn in the empty spaces of the elicitation frame form 1800. In such manner the instructor and the student may progress through each lesson at an individuated pace prescribed and modified from time to time by the instructor.

As an instructor observes the work product of each student, from time to time it may become apparent that a student is struggling with a particular task. This point in time, as evidenced by an inability to perform a particular task, or as evidenced by a decline in the quality of performance relative to past performance quality on prior tasks, constitutes a “point of commencement of struggle”, or “POCOS”. An observant instructor should then, along with the student, make the appropriate investment of time and effort required to bring the student back into a condition of success and out of the condition of struggle.

By this process of observation and investment of time and effort at the point of commencement of struggle, the instructor and the student combine their focus and efforts to initially slow the attempted rate of progress of learning until the student has demonstrated readiness to proceed. This condition of readiness to proceed is called individuated foundational readiness, or “IFR”. When a student has demonstrated foundational readiness to proceed to the next level of instruction, a certificate of achievement is issued by the instructor to the student in reward for successfully completing the prior prescribed level of instruction and memorializing that accomplishment for the student.

By way of summary and not limitation, the registration and lesson progress chart 3500 enables an instructor to:

1. target specific strokes, words, word patterns, phrases parts of speech and other grammatical and linguistic constructs for specified students;

2. identify patterns in class performance;

3. provide individuated and differentiated instruction;

4. group students based on common needs and strengths

5. measure generally what has been taught;

6. measure individual student learning;

7. align with standards;

8. engage the student;

9. be objective;

10. provide data that are helpful to students and parents.

Incorporation of the parent 134 into the instruction process, while not essential to any specific lesson or material, is nevertheless considered a significant element in the system 100. Contained within the system 100 are materials 134 which may be made available by instructors to parents of students. During the early stages of instruction of pre-school aged children, parents are instructed to perform certain tasks of which their child is aware but in which the child is not necessarily participating. Participation of the child is optional with the child. The parental tasks are easily performed and are generally related to similar tasks being performed by the child in class. Such a task might include, for example, drawing a picture of a house or a fictional character that is generally referred to in the system 100 as an instructional entity 114. These tasks are referred to as parental homework.

In the general manual 102 are listed and described ten reasons why parents of participating children are requested by an instructor to do homework:
1. Imitation: Children learn by imitating examples.
2. Seeds of learning: Children's imitation of their parents is a response to their drive for growth and independence. Parents can and should sow the seeds of learning early in a child's growth system by performing imitatable acts of parental homework.
3. Routines establish learning environment: Establishment of routines reduces and removes elements of doubt and fear from a child's thoughts and produces an environment in which a child can learn.
4. Safe activity: Observation of parents instills confidence in the child that the activity is safe and desirable.
5. Discipline: Discipline for children also means discipline for parents.
6. Curiosity: Observation leads to curiosity; curiosity leads to interest; and interest leads to discovery.
7. Delight: Children delight in learning with and from persons with whom they are emotionally related.
8. Pleasurable association: The emotional state a child is in at the moment learning takes place is imprinted as part of that learning. The natural pleasurable association of parent and child, linked with learning, can result in a lifetime of pleasurable association with learning for the child.
9. Memory: Memory centers are connected repeatedly and redundantly to emotional processing centers in the brain, thereby making it possible to both file and retrieve information more easily when pleasurable associations accompany the filing of that information.
10. Inspiration: Parents have countless opportunities to teach and inspire by example. Remember, children learn by imitating examples.

Parental involvement is potentiated by access to knowledge relevant to teaching the arts of writing and reading to their children. Therefore, updateable references to current research in the field are included in a compendium 134 of parental information and materials.

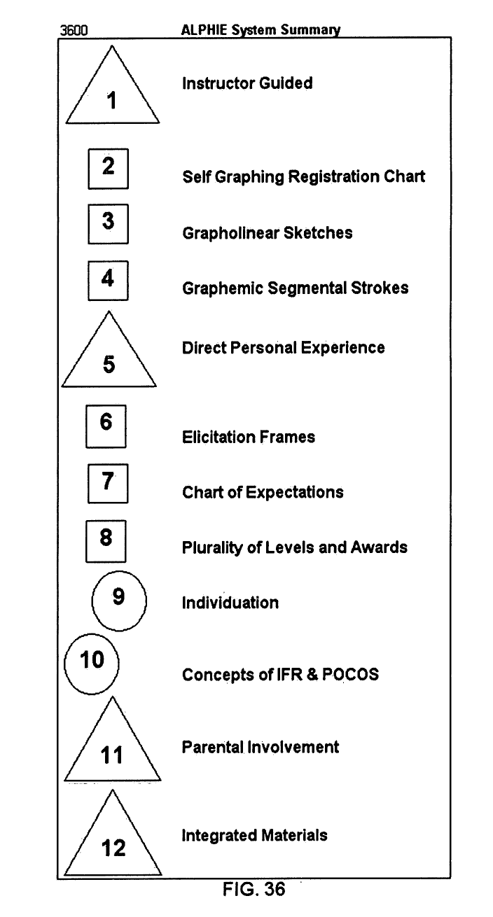

FIG. 36 depicts the System Summation Chart, the function of which is similar to the system 100 chart depicted in FIG. 1 in its description of the present invention, It differs primarily from the system 100 chart in its streamlined nature and its design which is similar to a flow chart.

The System 100 Summation Chart 3600 describes twelve aspects of the system 100 numbered in such manner so as to separate the aspects into categories, the categories being:
1. internal: defined as being an actual part of the physical embodiment of the present invention, represented by a number placed within a square block;
2. external: defined as existing outside the physical embodiment of the invention but being integral to the operation of the system 100 of the present invention, represented by a number placed within a triangle; and
3. conceptual: defined as existing conceptually as either a realized benefit or potential benefit of the present invention, represented by a number placed within a circle.

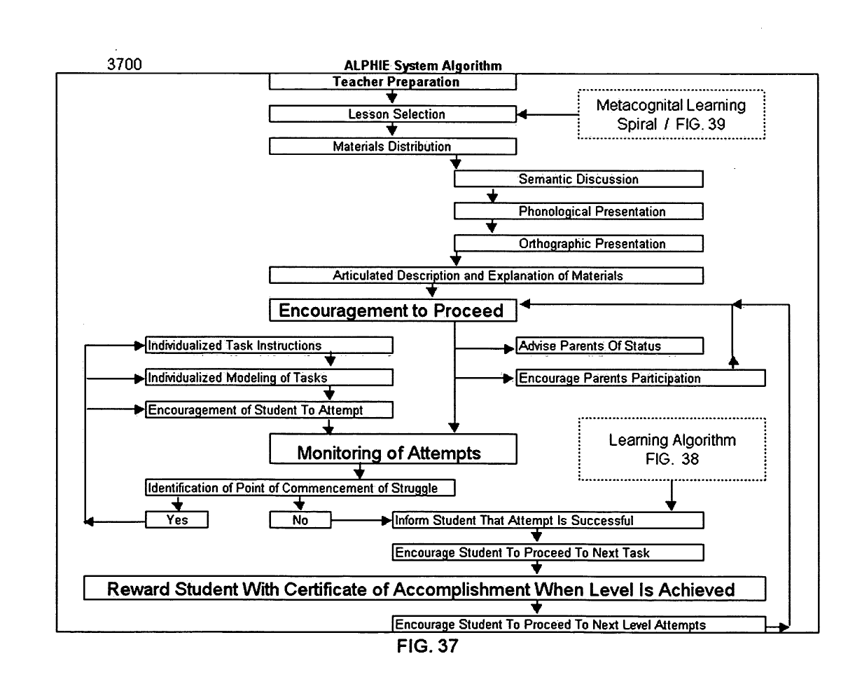

FIG. 37 depicts the system 100 algorithm chart. The system 100 algorithm chart 3700 may be used in concert with the system 100 chart presented in FIG. 1, the system 100 summation chart 3600 presented in FIG. 36, the learning algorithm 3800 FIG. 38, the metacognital learning and transfer spiral 3900 FIG. 39, or a combination of any two, three, four or five of the charts, as all five charts, individually and collectively describe a system 100 designed to enable high levels of student achievement that are the result of systematic, targeted and purposeful instruction combined with the skillful use of classroom data as depicted in the registration chad 3500 that allows an instructor to identify strengths and weaknesses in student learning, monitor student progress toward specified goals, make adjustments in instruction, and measure the degree to which students meet expectations, and keep all interested parties updated and actively participating.

As is evidenced by the existence of over 100,000 studies probing the art of reading, teaching this art and the corollary art of writing presents far more complex issues than might be surmised by the average parent and average teacher as well. In an attempt to disambiguate this complexity relative to the methods of the present invention, three charts have been presented in FIG. 1, FIG. 36 and FIG. 37 that individually and collectively describe the system of the invention in its entirety. Two additional charts, FIG. 38 and FIG. 39, describe aspects of procedures initially graphically presented in FIG. 37 which depicts the algorithmic nature of the methods of the invention system.

The initial emphasis of the system of the present invention is on learning to write in order to learn to read. Recent evidence for the validity of this paradigm reversing approach is neuro-scientifically based. Joint research by Harvard and Boston University scientists has found that the “visual” cortex of the brain is utilized by Braille readers as well. When a sightless test subject imagined items he had touched, parts of his visual cortex were mildly activated. But when the subject drew, his visual cortex lit up as though he were seeing. (See reference to Alison Motluk).

The argument has been made that one can arrive at the same mental picture via different senses, in fact, integrating all sensations of an object into a mental image of it. “Seeing is as much touching as it is seeing. We are just unaware of it.”, says Alvaro Pascual-Leone, one of the Harvard scientists conducting the above referenced research.

Because the act of reading can be performed from what appears to the eye of an untrained observer to be a state of inaction, it apparently is thought that learning to read should be taught by a passive absorption technique. However, this currently universally practiced approach fails to see the amazing dance-like performance occurring as the printed images move from paper to retina to brain, from scribble to recognition to remembrance of meaning, from code to decoding, from insignificance to high emotional significance, from visual cortical stimulation to hippocampal modulation of the amygdala.

Therein may lie the crux of at least one of the problems plaguing teachers, parents and students alike: reading is an activity that is not taught as an skill activity, in other words, reading is not considered to be an action skill. It is, instead, considered to be, and taught as if it were, an intellectual accomplishment. Consequently, reading is taught passively, as if it were water being dripped onto a sponge. However, analogously speaking, consider which is the better sponge: one that sits and waits for water to fall upon it, or one that actively seeks out the water and craves to absorb it For the most part, our brains are craving brains. (See reference to Ruden, R., “The Craving Brain”) They function best when actively seeking out and actively performing information absorption.

Accordingly, the present invention encourages active participation of the student in the process of learning to write and read by incorporation of the student's manually self produced art into the process and procedures of the system. This, by analogy to Braille and Morse code, (consider that Braille is also an alphabet wherein the visual medium has been completely replaced by the tactile one, and that Morse code is an alphabet wherein both the visual and tactile media have been completely replaced by the audial one), has previously been shown to be neurologically relevant. However, the relevance may be even greater than generally realized if the presently debated claims of “Semiogenetic Theory” regarding the conditions of emergence of language, especially that hand gestures have been transformed into articulatory gestures synchronized by means of brain-mediated somatotopically mapped circuits, (see separate references to Corballis and Philps), are accepted. By deduction, these claims appear to demonstrate at least the possibility, if not the probability, that the brain is evolutionarily disposed to develop and comprehend manual signs, and therefore, by extension, to both make writing and to comprehend it, a process which may have begun five million years ago (see reference to McNeil).

Of greater certainty at this time is the belief that the brain is also evolutionarily disposed to engineer safety and self defense of the organism as its primary responsibilities. Presentation of any stimulus will initially be considered by the brain from safety and self defense points of reference. A stimulus which is not understood by the organism results in confusion for the organism, an undesirable state. Therefore, the stimulus may be ignored, avoided or blocked by the brain as a defense mechanism response to the stimulus. Any stimulus that is perceived as a potential source of confusion may be blocked by the brain. In addition, any stimulus, whether or not previously encountered and cataloged by the organism, may be blocked by the brain. Consequently, any new or previously encountered (i.e., not new) stimulus may be blocked regardless of whether it will in fact lead to benefits or dangers for the organism depending on the current affective state of the organism.

For this reason, (that the brain may block potentially beneficial as well potentially harmful stimuli), the value of development of metacognitive skills that allow the organism to analyze and catalog stimuli in such manner as to more likely allow potentially beneficial stimuli to be perceived as potentially beneficial rather than potentially harmful, and consequently to remain unblocked and now-actionable by the organism, and to do so in a positive affective state, is clearly apparent. The capabilities of the brain for perceiving stimuli as blockable, deferrable or now-actionable are graphically described 3800 as the brain's learning algorithm in FIG. 38.

The present invention is a true writing based system that teaches children to learn to read. It differs significantly and dramatically from the program entitled “Writing Road to Reading” that is also known as “The Spaulding Method”. Whereas the Spaulding-Writing Road method defers commencement of teaching a child to write until a base vocabulary of 150 words has been memorized, the ALPHIE system commences to teach writing in its first lesson and grows its vocabulary from words the child has learned to write.

Whereas the Spaulding-Writing Road method incorporates prior knowledge that is unrelated to writing in the form of the construction of the face of a clock and knowledge of its corresponding numerals, the ALPHIE system draws upon the related prior experience of children to scribble and make marks.

Whereas the Spaulding-Writing Road method chooses to avoid utilization of the practice of copying letters, the ALPHIE method teaches children how to imitate letters and provides numerous opportunities to copy samples of letters and words.

Whereas it is stated in Spaulding-Writing Road to Reading, edition 5, that comprehension training cannot begin until after the relationship between printed letters and their represented sounds have been mastered to the point of automaticity, the ALPHIE system fosters comprehension of the letter-sound relationship and extends comprehension to the meaning of the words written by the child simultaneously with the writing of the words.

Whereas the Spaulding-Writing Road method offers no specific training in what it calls Stage 3 (the beginning of higher order learning and thinking skill acquisition), Stage 4 (analytical reasoning) and Stage 5 (synthetic reasoning) until after Stage 1 (recognition of the alphabetic principle) and Stage 2 (expansion and consolidation of the alphabetic principle) are mastered, the ALPHIE system integrates these stages into a single stage method which it considers to be an expandable, circuitous spiral of knowledge growth of which all children are capable without imposing an artificial requirement of prior knowledge acquisition, training and mastery.

Whereas the Spaulding-Writing Road method defers the commencement of instruction in spelling until nearing the end of kindergarten after a child has been taught a set of 70 letter phoneme units called phonograms, the ALPHIE system commences teaching sound relationships, writing and spelling several years sooner as a single, integrated method.

Whereas the Spaulding-Writing Road method teaches 70 phonemes in isolation without word relevance prior to commencement of teaching actual writing, a more than 100 year old method, the ALPHIE system commences with actual writing and relates the phonemes it is teaching to words the child is familiar with and currently using.

Whereas the Spaulding-Writing Road method teaches a base vocabulary of 150 words without sentence relevance prior to commencement of teaching actual writing, a more than 100 year old method, the ALPHIE system commences teaching sentence relevance and structure after only 2 words have been learned by the student.

The present invention, through its system and methods, can significantly contribute to the achievement of the major goals of the Reading Excellence Act of 1997 cited in US House Report 105-348:

Goal 1: Teach every child to read as soon as they are ready;

Goal 2: Improve instruction practices for teachers;

Goal 3: Provide better training for teachers;

Goal 4: Reform the way reading is taught within the school;

Goal 5: Insure that parents have the literacy skills necessary to help their children come to school ready to learn to read;

Goal 6: Increase parental involvement.

Goal 7: reduce or eliminate the “ . . . profound lack of information provided to reading instructors on the fundamental basics in teaching children to read.”

Goal 8: reduce or eliminate the number of children who are mislabeled as “learning disabled” who in fact are not learning disabled but instead have not been taught to read.

The present invention systematically incorporates the mandate of the National Institute For Literacy to utilize scientifically based reading research as the “newest standard of quality” and within this mandate directly addresses each of the eight goals listed above. Specifically, the present invention;

provides the means, materials and instructor mandate to increase parental involvement;

provides an opportunity to enhance parental literacy through a parental homework program;

provides an opportunity to reform the way reading is taught in school by teaching the art of writing as preliminary to teaching the art of reading;

provides further opportunity to reform the way reading is taught in school through utilization of levels driven instruction rather than age or class driven instruction;

provides further opportunity to reform the way reading is taught in school by incorporating a philosophy of individuated instruction and by further providing the means and method to accomplish individuated instruction;

provides further opportunity to reform the way reading is taught in school by incorporating each student's personal experiences and personal production of art into each level of instruction;

provides explicit step by step instruction for the instructor in the use of prescribed materials and fulfillment of course objectives;

provides current and updatable references to research relative to the materials and methods of the system of the present invention.

The ALPHIE system employs materials and teaching techniques which further benefit the student by:

1, combining natural artistic capabilities and propensities of children into production of twelve distinct useful marks called pre-graphemic segments;

2. building a foundation of self directed and self regulated activity;

3. training focus and concentration by teaching the child to draw figures which are likely to be emotionally relevant to the child, utilizing the 12 pre-graphemic segments;

4. encouraging creation of abstractions;

5. encouraging concrete descriptions of abstractions;

6. teaching children to learn to learn by building an immersive awareness of the learning process; and

7. commencing its teaching capabilities at a substantially earlier time in the child's life.

1. An algorithmic system for facilitating teaching the art of writing to individuals aged one year and older who, having progressed through the system, are thereby enabled to write, read, speak and comprehend what they have written, said system comprising:
a general exemplary embodiment consisting of:
1. orthographic patterns called ‘graphemic segmental strokes’;
2. grapholinear sketches of scenes and characters called ‘instructional entities’ composed entirely of graphemic segmental strokes;
3. elicitation frame forms used to model graphemic segmental strokes, graphemes, words and sentences and to provide practice space in close proximity to the models;
4. a framework of instructional materials called a ‘chart of expectations’;
5. defined, instructor guided, sequentially preferred interactions of the instructor with the student and instructional materials;
6. direct personal experience of the student with the instructional materials developed through an interest elevating sequence of natural relevance and self interest;
7. a plurality of levels of instructional materials for establishing goals, and measuring and maintaining goals accomplished by students;
8. individuation by virtue of a method and capability to simultaneously teach different lessons in the same classroom to individual students;
9. the concept of individuated foundational readiness, or “IFR”;
10. the concept of a point of commencement of struggle, or “pocos”, that provides graphic notice to an observing instructor of a point of beginning of decline in accomplishment by a student;
11. a registration chart enabling the instructor to accomplish individuated instruction, provides notice to the instructor that a student has successfully completed a prescribed level of endeavor and indicates that a reward in the form of a ribbon, prize or certificate of accomplishment should be issued to the student; and
12. a ‘learning-to-learn’ sub-skill development philosophy designed to foster general metacognitive skills emphasizing attention control, goal setting, self evaluation and self regulation of learning.
and also comprising:
defining the algorithm by which the system proceeds to consist of the primary steps of:
teacher preparation;
lesson selection;
materials distribution;
articulated description and explanation of materials;
encouragement to proceed;
advising parent of status;
encouraging parental involvement;
monitoring of attempts;
determining of points of commencement of struggle, when present;
informing students when attempts are successful;
encouraging students to proceed to the next task;
rewarding students when appropriate;
encouraging students to proceed to the next level, when appropriate.
defining the algorithm by which the system proceeds to be inclusive, where appropriate, of the secondary steps of:
semantic discussions;
phonological presentations;
orthographic presentations;
individualized task instructions;
individualized modeling of tasks;
defining the term ‘graphemic’ for use within the system to mean as being of, or a part or particle of, or a segment or segmental part of, or like or related to graphemes;
defining the terms ‘orthographic marks’, ‘orthographic lines’ and ‘orthographic patterns’ for use within the system to be interchangeable synonyms and to mean or refer to a class of lines, marks or patterns drawn, made or printed in such manner as to be utilizable in the correct formation of graphemes;
defining the term ‘graphemic segmental strokes’ for use within the system, whether by stipulating, specifying, qualifying, providing, drawing or rendering, whether graphically or otherwise, to mean one or more of the set of twelve specific orthographic marks, lines or patterns, the making, writing, printing or drawing of which, whether alone or in combination with one or more of the set of twelve specific orthographic marks, lines or patterns, is intended to result in the making, writing, printing or drawing of a grapheme;
defining the terms ‘grapholinear graphemic segmental stroke figures’, ‘grapholinear segmental stroke figures’, and ‘graphemic segmental stroke figures’ for use within the system to be interchangeable synonyms and to mean drawings or sketches of objects, scenes or animate characters composed entirely of graphemic segmental strokes;
defining the term ‘graphemic instructional entities’ for use within the system to mean grapholinear graphemic segmental stroke figures composed entirely of graphemic segmental strokes utilized or utilizable as a method of teaching students to make, draw, write or print graphemic segmental strokes and full graphemes;
defining, as an element for use within the system, whether by stipulating, specifying, qualifying, providing or rendering, whether graphically or otherwise, a complete set of twelve printed graphemic segmental strokes as a subset of the orthographic set commonly referred to as graphemes, which subset of graphemic segmental strokes is comprised of six linear or straight line strokes, five curvilinear strokes, and one stroke which is neither a straight line nor a curved line but consists entirely of a single point or dot;
defining, as an element for use within the system, a complete set of twelve printed graphemic segmental strokes, whether by stipulating, specifying, qualifying, providing or rendering, whether graphically or otherwise, as consisting of: one vertical straight line creating a 90 degree angle with the horizontal axis; one slanted straight line ascending from left to right creating an angle which may approximate a 45 degree angle with the horizontal axis but which may in usage create an angle greater or less than 45 degrees with the horizontal axis; one straight line ascending from right to left creating an angle which may approximate a 45 degree angle with the horizontal axis but which may in usage create an angle greater or less than 45 degrees with the horizontal axis; one straight line running horizontally in lower relation to a second straight line running horizontally in a median position relative to a third horizontally running straight line and the low straight line running horizontally; one circular pattern; one semi circular pattern drawn from the top right running leftward; one semi circular pattern running from the top left running rightward; one “U” shaped pattern; one quarter circular pattern drawn from the left with a centered apogee; and one dot which is neither a straight line nor a curve;
defining, as an element and establishing for use within the system, the preferred name or names of each member of the set of twelve graphemic segmental strokes to be: ‘wall’ or ‘straight line’ for the one vertical straight line creating a 90 degree angle with the horizontal axis; ‘pole’ or ‘flag pole’ for the one slanted straight line ascending from left to right creating an angle which may approximate a 45 degree angle with the horizontal axis but which may in usage create an angle greater or less than 45 degrees with the horizontal axis; ‘stick’ for the one straight line ascending from right to left creating an angle which may approximate a 45 degree angle with the horizontal axis but which may in usage create an angle greater or less than 45 degrees with the horizontal axis; ‘foot’ or ‘low line’ for the one straight line running horizontally in lower relation to a second straight line running horizontally in a median position relative to a third horizontally running straight line and the low straight line running horizontally; ‘cross’ or ‘across’ or ‘middle line’ for the straight line running horizontally in a median position relative to a third horizontally running straight line and the low straight line running horizontally; ‘high line’ or ‘top line’ for the third horizontally running straight line that is neither the lowest nor the median line of the three horizontally running straight lines; ‘circle’ or ‘o’ for the one circular pattern; ‘ear’ or ‘c’ for the one semi circular pattern drawn from the top right running leftward; ‘belly’ for the one semi circular pattern running from the top left running rightward; ‘cup’ or ‘u’ for the one “U” shaped pattern; ‘eye brow’ or ‘bump’ or ‘rainbow’ for the one quarter circular pattern drawn from the left with a centered apogee; and ‘dot’ or ‘point’ for the one dot which is neither a straight line nor a curve;
defining as an element for use within the system, whether by stipulating, specifying, qualifying, providing or rendering, whether graphically or otherwise, an exemplary printed grid of elicitation frames into which frames, initially, elicited graphemic segmental strokes are drawn, subsequently then progressing to the elicitation of drawing complete graphemes, subsequently then progressing to the elicitation of drawing complete words, and subsequently then progressing to the elicitation of writing complete phrases and sentences; then progressing to the utilization of non-printed situational elicitation frames for development of advanced writing techniques;
defining as an element for use within the system, whether by stipulating, specifying, qualifying, providing or rendering, whether graphically or otherwise, an exemplary Level One instructor's chart of expectations form graphically displaying and delineating the number of lessons to be taught by the instructor, the number of phonemes to be taught in each particular lesson, the specific phonemes to be taught in each particular lesson, the number of miniscule and majuscule letters to be taught in each particular lesson, the specific miniscule and majuscule letters to be taught in each particular lesson, the number of punctuation marks to be taught in each particular lesson, the specific punctuation marks to be taught in each particular lesson, the number of numbers to be taught in each particular lesson, the specific number or numbers to be taught in each particular lesson, the number of words to be taught in each particular lesson, the specific word or words to be taught in each particular lesson, the number of sentences to be taught in each particular lesson, the specific sentence or sentences to be taught in each particular lesson, an indication that any particular lesson will include the issuance of an award, prize or reward upon completion to the student, and a description of the award, prize or reward to be awarded to the student upon completion of the lesson;
defining as elements for use within the system, whether by stipulating, specifying, qualifying, providing or rendering, whether graphically or otherwise, exemplary instructor's charts of expectations forms for each level of instruction beyond Level One graphically displaying and delineating the subject matter to be taught in similar manner to the depiction and display utilized in the Level One chart of expectations;
defining as an element for use within the system, whether by stipulating, specifying, qualifying, providing or rendering, whether graphically or otherwise, an exemplary self graphing registration and progress log form for inscribing and registering the name of each individual person participating as an instructee in the system, said registration log form including, at minimum, defined and labeled data entry fields for provision of the name of the instructor, the level of instruction and the name of the class; said log form further including a plurality of linearly defined and categorized rows and columns of such width and height as to provide sufficient space for typing or hand writing a start of instruction date for each of the lessons prescribed for the indicated level of instruction;
providing an exemplary group of grapholinear segmental stroke figure drawings referred to as graphemic instructional entities, each drawing consisting entirely of a complete set of the twelve distinct graphemic segmental strokes;
providing a particular exemplary segmental stroke figure drawing consisting of a complete set of the twelve distinct graphemic segmental strokes, which particular figure is an instructional entity named and referred to as Alphie, an acronym for Algorithmic, Lexiconic, Phonemic, Heuristic, Instructional, Entity;
providing not less than one pre-Level One level of instruction wherein young children aged approximately one to approximately two years are guided and encouraged to make marks and scribbles on provided paper with provided marking implements;
teaching the utilization of exemplary printed grids of elicitation frames into which frames, initially, graphemic segmental strokes elicited by printed example are drawn, subsequently then progressing to the elicitation by example of drawing complete graphemes, subsequently then progressing to the elicitation by example of drawing complete words, subsequently then progressing to the elicitation by example of drawing scenes and characters, and subsequently then progressing to the elicitation by example or suggestion of writing complete phrases and sentences;
teaching the orthographic manufacture of the complete set of twelve printed graphemic segmental strokes which set constitutes a subset of the orthographic set commonly referred to as graphemes, which subset of graphemic segmental strokes is comprised of six linear or straight line strokes, five curvilinear strokes, and one stroke which is neither a straight line nor a curved line but consists entirely of a single point or dot;
teaching in a non-sequential arrangement the construction of graphemes from graphemic segmental strokes;
providing an exemplary Level One level of instruction for commencing teaching children, aged approximately two years and older:
1. to draw orthographic patterns by drawing characters and scenes on provided paper with provided drawing and marking implements;
2. then progressing to production of specific pre-graphemic orthographic patterns;
3. then progressing to production of specific graphemes;
4. then progressing to production and recognition of the conventional names of graphemes;
5. then progressing to production and recognition of the various divergent sounds associated with specific graphemes;
6. then progressing to production and recognition of specific words chosen for their likelihood of utility, natural relevance and interest to the child;
7. then progressing to production and recognition of the various divergent sounds associated with specific words;
8. then progressing to the production of an instructional entity from graphemic segmental strokes;
9. then progressing to writing the name of the produced instructional entity; and
10. then progressing to production, reading and comprehension of sentences;
providing an exemplary Level Two level of instruction for continuing to teach children who have successfully completed Level One of the system:
1. to draw orthographic patterns by drawing characters and scenes on provided paper with provided drawing and marking implements;
2. then progressing to production of specific pre-graphemic orthographic patterns;
3. then progressing to production of specific graphemes;
4. then progressing to production and recognition of the conventional names of graphemes;
5. then progressing to production and recognition of the various divergent sounds associated with specific graphemes;
6. then progressing to production and recognition of specific words chosen for their likelihood of utility, natural relevance and interest to the child;
7. then progressing to production and recognition of the various divergent sounds associated with specific words;
8. then progressing to the production of an instructional entity from graphemic segmental strokes;
9. then progressing to writing the name of the produced instructional entity; and
10. then progressing to production, reading and comprehension of sentences;
teaching the utilization of exemplary blank printed grids of elicitation frames into which frames, initially, verbally elicited graphemic segmental strokes are drawn, subsequently then progressing to the verbal elicitation of drawing complete graphemes, subsequently then progressing to the verbal elicitation of drawing complete words, subsequently then progressing to the verbal elicitation of drawing scenes and characters, and subsequently then progressing to the writing of verbally elicited complete phrases and sentences;
specifying the utilization of non-printed situational elicitation frames for the development of writing techniques of such character and nature as to be considered to be advanced beyond the practical utilization of printed elicitation frames;
specifying for inclusion on each level of instruction not less than one sample of each student's own prior produced art, which art is intended to serve or function as a situational elicitation frame of natural relevance and interest to the child;
specifying for inclusion on each level of instruction not less than one sample of each student's own prior produced linguistic effort, which linguistic effort is intended to serve or function as a situational elicitation frame of natural relevance and interest to the child;
teaching the utilization of non-printed situational elicitation frames for the development of writing techniques of such character and nature as to be considered to be advanced beyond the practical utilization of printed elicitation frames;
providing a plurality of exemplary levels of instruction, maintaining incorporation of subject matter selected in part for natural relevance and personal interest to the student, similar in form and structure to Levels One and Two but beyond Levels One and Two with regard to subject matter, for continuing to teach children who have successfully completed Levels One and Two of the system, of such number to be sufficient to allow an appropriate quantity of instructional content so as to enable students, upon successful completion of the plurality of levels, to write, read, speak and comprehend what they have written on a level of instruction and comprehension generally commensurate with generally established criteria for eight years of elementary school education in the United States;
providing a further plurality of exemplary levels of instruction, maintaining incorporation of subject matter selected in part for natural relevance and personal interest to the student, similar in form and structure to previous Levels, of such number sufficient to allow a sufficient quantity of instructional content as to enable its students, upon successful completion of the plurality of levels, to write, read, speak and comprehend what they have written on a level of instruction and comprehension generally commensurate with generally established criteria for four years of high school education in the United States;
providing a general instruction manual incorporating all specific instructional manuals together with generalized instructions, materials and information relevant to the implementation of current knowledge enabling and facilitating teaching the arts of writing and reading;
providing a specific instruction manual for facilitating the methodologies of instruction utilizing graphemic instructional entities, in general, and with the Alphie graphemic instructional entity in particular;
providing a specific instruction manual for facilitating the prescribed methodology of instruction utilizing the printed grid of elicitational frames for lessons that constitute Level One of the series program;
providing a specific instruction manual for facilitating the prescribed methodology of instruction utilizing printed grids of elicitational frames for each set of lessons that constitute a level beyond Level One of the series program;
providing a specific instruction manual for facilitating the prescribed methodology of instruction utilizing non-printed situational elicitation frames for each level of instruction wherein a non-printed situational elicitation frame format is appropriate;
providing a specific instruction manual wherein the words or sentences of each specified lesson are written in an orthography comprising: (a) letters written in plain text; (b) markings proximate to each letter or combination of letters to designate, if a consonant, the appropriate sound of the consonant or combination of consonants, or, if a vowel, whether the vowel has a short, long or soft sound or; (c) markings to designate letter combinations which have a single sound; (d) markings to designate letters or letter combinations which are silent; (e) proximate to each vowel, a key to pronunciation, or an image of an object the name of which is indicative of the sound of the vowel or vowels to which the image is proximate, or both; and (f) proximate to each single-sound letter or letter combinations, either a key to pronunciation, or an image of an object the name of which is indicative of the sound of the letter or letter combination, or both;
providing exemplary script and advice to instructors regarding vocalization by the instructor of all vowel sounds, consonant sounds, and combinations thereof, when dictated by the lesson instructions that such sounds are to be made audible to a student during the particular lesson;
providing exemplary script and advice to instructors regarding vocalization by the instructor of the pronunciation of all vocabulary words, and combinations of vocabulary words, when dictated by the lesson instructions that such pronunciations are to be made audible to an instructee during the particular lesson;
providing exemplary script and advice to instructors regarding vocalization by the instructor of the combinations of vocabulary words comprising sentences, when dictated by the lesson instructions that such vocalizations are to be made audible to an instructee during the particular lesson;
providing materials for use by students in a classroom setting in the presence of an instructor in accordance with the instructions given by the instructor relevant to the subject matter of the lesson being taught;
providing materials for use by students either in a home or classroom setting, or elsewhere, in accordance with the instructions given by an instructor relevant to the subject matter of the lessons being taught currently, or previously taught, or to be taught at a subsequent time;
providing instructional materials for use by parents or other instructors in accordance with the instructions given by an instructor relevant to the subject matter of the lesson being taught currently, or previously taught, or to be taught at a subsequent time;
providing instructional “quick guides” for use by parents or other instructors in accordance with the instructions given by an instructor relevant to the subject matter of the lesson being taught currently, or previously taught, or to be taught at a subsequent time, which “quick guide” shall be an abbreviated form of a complete specific manual;
providing a compendium of integratable instructional materials for use by students, parents or other instructors in accordance with the instructions given by an instructor either relevant to or generally related the subject matter of the lessons being taught currently, or previously taught, or to be taught at a subsequent time;
providing by download from the internet, or otherwise, an updateable listing of references to books, articles and papers relevant to the general field of teaching students to write and read.

2. The system of claim 1, further providing for inclusion of a principled framework establishing an instructional philosophy incorporating, enabling and maintaining individuation, direct personal experiences of each student and individual foundational readiness of each student.

3. The system of claim 1, further providing for the inclusion, within its principled framework, of establishment of an instructional philosophy that seeks to engender an “I can do this” attitude on the part of the student.

4. The system of claim 1, further providing for the inclusion, within its principled framework, of establishment of an instructional philosophy that seeks to engender an “I want to do this” attitude resulting from a development of natural relevance of the subject matter to the student.

5. The system of claim 1, further providing for the inclusion, within its principled framework, of establishment of an instructional philosophy that requires that self esteem engendered within the student be deserved by the student and earned as a consequence of successful completion of instructional tasks.

6. The system of claim 1, further providing for including the requirement of preparation and delivery to each student by an instructor of an award in the form of a prize, or ribbon or certificate of achievement in reward for successfully completing each prescribed level of instruction thereby memorializing each accomplishment for the student.

7. A method for the implementation of claim 1 utilizing an algorithmic method for teaching multiple parts of a language by a series program using printed elicitation frames, said method comprising the algorithmic steps of:
supplying lesson materials in an established order of presentation;
vocally describing and explaining the tasks and goals of the particular lesson materials;
vocally giving instructions to students regarding making attempts to perform the tasks required by the particular lessons;
vocally modeling the sound or sounds associated with letters or combinations of letters;
modeling the required lesson task performance for the students;
encouraging students to attempt to comply with the instructions given by the instructor regarding the tasks required by the particular lessons;
monitoring the attempts at task performance made by students;
identifying or determining when an individual student is demonstrating difficulty in correctly performing a specified task;
modeling correct performance for an individual student when said student has demonstrated having a difficulty with a particular task;
arranging additional practice opportunities for a student demonstrating difficulty in correctly performing a specified task;
analyzing and comparing a struggling student's new attempts at task performance with initial attempts;
repeating modeling of required tasks for a struggling student until said difficulty is overcome;
informing students of correct and incorrect task performance;
analyzing a student's rate of correct task performances;
determining an individual students foundational readiness to proceed to the next prescribed task or level of tasks;
preparing and delivering to each student an award in the form of a prize, ribbon or certificate of accomplishment upon the successful completion by the student of each level of instruction and endeavor;
encouraging individual students to proceed to the next prescribed task or level of tasks;
supplying new lesson materials and instructions to student's who have demonstrated a foundational readiness to progress to the next task or task level;
supplying lesson related materials to parents;
encouraging parents to participate in the instructional process with the student; and
advising parents of progress, rate of progress and frequency of task difficulty experiences of the said parents' individual student children.

8. A method for the implementation of claim 1 utilizing an algorithmic method for teaching multiple parts of a language by a series program using non-printed situational elicitation forms, said method comprising the algorithmic steps of:
supplying lesson materials in an established order of presentation;
encouraging students to produce art regardless of style, quality and content for inclusion and combination with specified lesson content;
requesting, at the discretion of the student and without penalty for declining for any reason, the submission of a sample of each student's own prior produced art which prior produced art is intended to serve or function as a situational elicitation frame;
encouraging students to produce written text regardless of style, quality and content for inclusion and combination with specified lesson content;
requiring submission of a sample of each student's own prior produced writing or, in the alternative, where such writing is unavailable or where the student prefers, to submit a newly created linguistic effort, regardless of style, quality and content, which prior produced or newly created writing is intended to serve or function as a situational elicitation frame;
vocally describing and explaining the tasks and goals of the particular lesson materials;
vocally giving instructions to students regarding making attempts to perform the tasks required by the particular lessons;
modeling the required lesson task performance for the students;
encouraging students to attempt to comply with the instructions given by the instructor regarding the tasks required by the particular lessons;
monitoring the attempts at task performance made by students;
identifying when an individual student is demonstrating difficulty in correctly performing a specified task;
modeling correct performance for an individual student when said student has demonstrated having a difficulty with a particular task;
arranging additional practice opportunities for a student demonstrating difficulty in correctly performing a specified task;
analyzing and comparing a struggling student's new attempts at task performance with initial attempts;
repeating modeling of required tasks for a struggling student until said difficulty is overcome;
informing students of correct and incorrect task performance;
analyzing a student's rate of correct task performances;
determining an individual students foundational readiness to proceed to the next prescribed task or level of tasks;
preparing and delivering to each student an award in the form of a prize, ribbon or certificate of accomplishment upon the successful completion by the student of each level of instruction and endeavor;
encouraging individual students to proceed to the next prescribed task or level of tasks;
supplying new lesson materials and instructions to student's who have demonstrated a foundational readiness to progress to the next task or task level;
supplying lesson related materials to parents;
encouraging parents to participate in the instructional process with the student; and
advising parents of progress, rate of progress and frequency of task difficulty experiences of the said parents' individual student children.
